(19) United States
(12) Patent Application Publication
(10) Pub. No.: US 2026/0025883 A1
(43) Pub. Date: Jan. 22, 2026

(54) Managing Multicast Communication for User Equipment Operating in an Inactive State

(71) Applicant: GOOGLE LLC, Mountain View, CA (US)

(72) Inventors: Chih-Hsiang Wu, Taoyuan City (TW); Ching-Jung Hsieh, Taipei City (TW)

(21) Appl. No.: 18/993,218

(22) PCT Filed: Jul. 12, 2023
(86) PCT No.: PCT/US23/27478

§ 371 Date: Jan. 10, 2025

Related U.S. Application Data
(60) Provisional application No. 63/388,289, filed on Jul. 12, 2022.

(51) Int. Cl. H04W 76/40; H04W 72/1263

(52) U.S. Cl. CPC H04W 76/40; H04W 72/1263

(57) ABSTRACT

A radio access network. RAN, participating in a multicast and broadcast services. MBS, session can implement a method for managing MBS communication. The method includes: transmitting (702), to a first UE operating in a connected state, a first multicast configuration for receiving MBS data in the inactive state: transmitting (703), to a second UE operating in the connected state, a second multicast configuration for receiving the MBS data in the connected state; and transmitting (708) the MBS data to the first UE operating in the inactive state, according to the first multicast configuration and the second UE operating in the connected state, according to the second multicast configuration.

### CROSS-REFERENCE TO RELATED APPLICATIONS

This application claims priority to and the benefit of the filing date of provisional U.S. Patent Application No. 63/388,289 entitled “MANAGING MULTICAST COMMUNICATION FOR USER EQUIPMENT OPERATING IN AN INACTIVE STATE,” filed on Jul. 12, 2022. The entire contents of the provisional application are hereby expressly incorporated herein by reference.

### FIELD OF THE DISCLOSURE

This disclosure relates to wireless communications and, more particularly, to enabling one or more multicast and/or broadcast services (MBS) for a user equipment (UE) operating in an inactive state.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP sublayer provides sequencing of protocol data units (PDUs) in the uplink direction from a user device (also known as a user equipment or “UE”) to a base station (BS), as well as in the downlink direction from the base station to the UE. The PDCP sublayer also provides services for signaling radio bearers (SRBs) to the Radio Resource Control (RRC) sublayer. The PDCP sublayer further provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, depending on the scenario, the UE and a base station use SRBs to exchange RRC messages as well as non-access stratum (NAS) messages, and use DRBs to transport data on a user plane.

The UE in some scenarios concurrently utilizes resources of multiple nodes (e.g., base stations or components of a distributed base station or disaggregated base station) of a radio access network (RAN), interconnected by a backhaul. When such network nodes support different radio access technologies (RATs), this type of connectivity is referred to as multi-radio dual connectivity (MR-DC). When operating in MR-DC, the cell(s) associated with the base station operating as a master node (MN) define a master cell group (MCG), and the cells associated with the base station operating as a secondary node (SN) define the secondary cell group (SCG). The MCG covers a primary cell (PCell) and zero, one, or more secondary cells (SCells), and the SCG covers a primary secondary cell (PSCell) and zero, one, or more SCells. The UE communicates with the MN via the MCG and the SN via the SCG. In other scenarios, the UE utilizes resources of one base station at a time, in single connectivity (SC). The UE in SC communicates with the MN, via the MCG. A base station and/or the UE determine when the UE should establish a radio connection with another base station. For example, a base station determines to hand the UE over to another base station and initiates a handover procedure. The UE in other scenarios concurrently utilizes resources of another RAN node (e.g., a base station or a component of a distributed or disaggregated base station), interconnected by a backhaul.

Depending on the scenario. UEs use several types of SRBs and DRBs. “SRB1” resources carry RRC messages, which in some cases include NAS messages over the dedicated control channel (DCCH), and “SRB2” resources support RRC messages that include logged measurement information or NAS messages over the DCCH, but with lower priority than SRB1 resources. More generally, SRB1 and SRB2 resources allow the UE and the MN to exchange RRC messages related to the MN and embed RRC messages related to the SN, and can also be referred to as MCG SRBs. “SRB3” resources allow the UE and the SN to exchange RRC messages related to the SN, and can also be referred to as SCG SRBs. Split SRBs allow the UE to exchange RRC messages directly with the MN via lower-layer resources of the MN and the SN. Further. DRBs terminated at the MN and using the lower-layer resources of only the MN can be referred as MCG DRBs, DRBs terminated at the SN and using the lower-layer resources of only the SN can be referred as SCG DRBs, and DRBs terminated at the MN or SN but using the lower-layer resources of both the MN and the SN can be referred to as split DRBs. DRBs terminated at the MN but using the lower-layer resources of only the SN can be referred to as MN-terminated SCG DRBs. DRBs terminated at the SN but using the lower-layer resources of only the MN can be referred to as SN-terminated MCG DRBs.

In some scenarios, UEs perform handover procedures to switch from one cell to another, whether in SC or DC operation. These procedures involve messaging (e.g., RRC signaling and preparation) among RAN nodes and the UE. The UE performs a handover from a cell of a serving base station to a target cell of a target base station, or from a cell of a first distributed unit (DU) of a serving base station to a target cell of a second DU of the same base station, depending on the scenario. In some DC scenarios, UEs performs PSCell change procedures to change PSCells. These procedures involve messaging (e.g., RRC signaling and preparation) among RAN nodes and the UE. The UE performs a PSCell change from a PSCell of a serving SN to a target PSCell of a target SN, or from a PSCell of a source DU of a base station to a PSCell of a target DU of the same base station, depending on the scenario. Further, the UE performs handover or PSCell change within a cell for synchronous reconfiguration.

For broadcast communication service, the same service and the same specific content data are provided simultaneously to all UEs in a geographical area (i.e., all UEs in the broadcast service area are authorized to receive the data). A broadcast communication service is delivered to the UEs using a broadcast session. Depending on the scenario, a UE receives a broadcast communication service in RRC_IDLE. RRC_INACTIVE, and/or RRC_CONNECTED states. For multicast communication service, the same service and the same specific content data are provided simultaneously to a dedicated set of UEs (i.e., not all UEs in the multicast service area are authorized to receive the data). A multicast communication service is delivered to the UEs using a multicast session.

RAN nodes use multicast for UEs operating in the RRC_CONNECTED state, which may not fully fulfil the requirements for important services, such as Mission Critical Services, especially for cells with a large number of UEs. Also, maintaining the RRC_CONNECTED state is not power efficient for UEs. It is therefore desirable to support multicast for UEs in the RRC_INACTIVE state. However, it is not clear how to enable multicast for UEs operating in the RRC_INACTIVE state.

### SUMMARY

In a single MBS session, one UE receives data in a connected state, and another UE receives MBS data in the same session in an inactive state. A CN and/or a RAN node manage the data transmission for the MBS session. The RAN node, depending on the implementation, transmit multicast configurations to the UEs while in the connected state for the UEs to use in receiving the MBS data in the inactive or connected state.

One example embodiment of these techniques is a multicast and/or broadcast services (MBS) communication method, implemented in a radio access network (RAN). The method includes: transmitting, to a first UE operating in a connected state, a first multicast configuration for receiving MBS data in the inactive state; transmitting, to a second UE operating in the connected state, a second multicast configuration for receiving the MBS data in the connected state; and transmitting the MBS data to (i) the first UE operating in the inactive state, according to the first multicast configuration and (ii) the second UE operating in the connected state, according to the second multicast configuration.

### BRIEF DESCRIPTION OF THE DRAWINGS

FIG. 1A is a block diagram of an example system in which the techniques of this disclosure for managing multicast radio resources may be implemented;

FIG. 1B is a block diagram of an example base station in which a centralized unit (CU) and a distributed unit (DU) can operate in the system of FIG. 1A;

FIG. 2A is a block diagram of an example protocol stack according to which the UE of FIG. 1A can communicate with base stations of FIG. 1A;

FIG. 2B is a block diagram of an example protocol stack according to which the UE of FIG. 1A can communicate with a DU and a CU of a base station;

FIG. 3 is a block diagram of an example tunnel architectures for MBS sessions and PDU sessions;

FIG. 4 is a block diagram of an example tunnel architectures for MRBs and DRBs;

FIG. 5A is a messaging diagram of an example scenario in which a CN and a RAN node of FIGS. 1A and/or 1B manage the transmission of downlink data for an MBS session to a UE operating in a connected state;

FIG. 5B is a messaging diagram of an example scenario similar to FIG. 5A, but in which the CN and the RAN node perform a distribution setup prior to performing a bearer context setup;

FIG. 5C is a messaging diagram of an example scenario similar to FIGS. 5A and 5B, but in which the CN transmits a message to the RAN node, including first QoS flow configurations for generating second QoS flow configurations;

FIG. 5D is a messaging diagram of an example scenario similar to FIGS. 5A-5C, but in which the RAN node determines to cause the UE to transition to an inactive state after performing the MBS data transmission for the first MBS session;

FIG. 5E is a messaging diagram of an example scenario similar to FIG. 5D, but in which the RAN node transmits a message to the UE to reconfigure radio resources rather than release the radio resources;

FIG. 6 is a flow diagram of an example method in which a RAN node of FIGS. 1A and/or 1B configures multicast configuration parameters and transmits MBS data packet(s) to a UE operating in an inactive state;

FIG. 7 is a flow diagram of an example method in which a RAN node of FIGS. 1A and/or 1B (i) configures different sets of multicast configuration parameters for at least one first UE and at least one second UE and (ii) transmits MBS data packet(s) to the first UE(s) operating in an inactive state and the second UE(s) in a connected state;

FIG. 8A is a flow diagram of an example method in which a RAN node of FIGS. 1A and/or 1B enables a UE to receive MBS data packet(s) in a connected state or in an inactive state;

FIG. 8B is a flow diagram of an example method similar to FIG. 8A, but in which the RAN node transmits first multicast configuration parameters or second multicast configuration parameters to the UE;

FIG. 9 is a flow diagram of an example method in which a CU of FIG. 1B performs procedures with a DU of FIG. 1B to configure a UE to receive MBS data packet(s) via the DU;

FIG. 10 is a flow diagram of an example method in which a CU of FIG. 1B determines whether to include an indication to a DU of FIG. 1B to provide multicast configuration parameters in an inactive state;

FIG. 11 is a flow diagram of an example method in which a DU of FIG. 1B performs procedures with a CU of FIG. 1B to send multicast configuration parameters and transmit MBS data packet(s) to a UE via multicast; and

FIG. 12 is a flow diagram of an example method in which a DU of FIG. 1B determines whether to include multicast configuration parameters for an inactive or connected state to a CU of FIG. 1B.

### DETAILED DESCRIPTION OF THE DRAWINGS

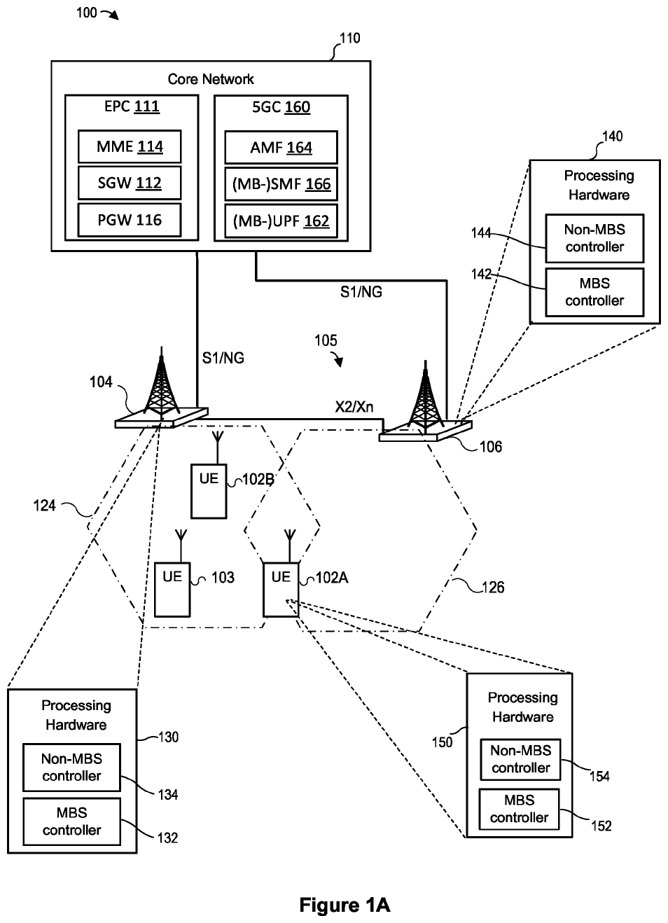

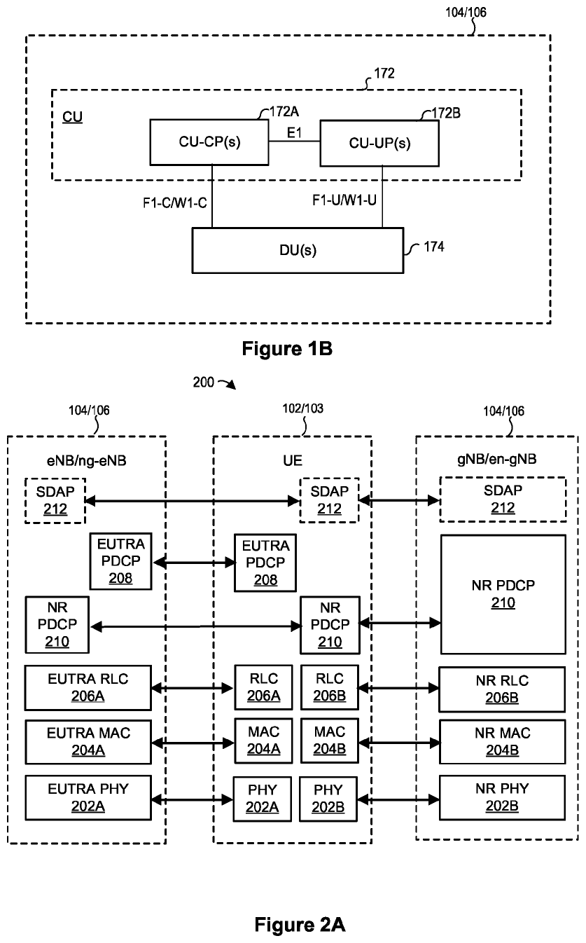

FIG. 1A depicts an example wireless communication system 100 in which techniques of this disclosure for managing transmission and reception of multicast and/or broadcast services (MBS) information can be implemented. The wireless communication system 100 includes user equipment (UEs) 102A, 102B, and 103 as well as base stations 104, 106 of a radio access network (RAN) 105 connected to a core network (CN) 110. In other implementations or scenarios, the wireless communication system 100 may instead include more or fewer UEs, and/or more or fewer base stations, than are shown in FIG. 1A. The base stations 104, 106 can be of any suitable type, or types, of base stations, such as an evolved node B (eNB), a next-generation eNB (ng-eNB), or a 5G Node B (gNB), for example. As a more specific example, the base station 104 may be an eNB or a gNB, and the base stations 106 may be a gNB.

The base station 104 supports a cell 124, and the base station 106 supports a cell 126. The cell 124 partially overlaps with the cell 126, so that the UE 102A can be in range to communicate with base station 104 while simultaneously being in range to communicate with the base station 106 (or in range to detect or measure signals from the base station 106). The overlap can make it possible for the UE 102A to hand over between the cells (e.g., from the cell 124 to the cell 126) or base stations (e.g., from the base station 104 to the base station 106) before the UE 102A experiences radio link failure, for example. Moreover, the overlap allows various dual connectivity (DC) scenarios. For example, the UE 102A can communicate in DC with the base station 104 (operating as a master node (MN)) and the base station 106 (operating as a secondary node (SN)). When the UE 102A is in DC with the base station 104 and the base station 106, the base station 104 operates as a master eNB (MeNB), a master ng-eNB (Mng-eNB), or a master gNB (MgNB), and the base station 106 operates as a secondary gNB (SgNB) or a secondary ng-eNB (Sng-eNB).

In non-MBS (unicast) operation, the UE 102A can use a radio bearer (e.g., a DRB or an SRB)) that at different times terminates at an MN (e.g., the base station 104) or an SN (e.g., the base station 106). For example, after handover or SN change to the base station 106, the UE 102A can use a radio bearer (e.g., a DRB or an SRB) that terminates at the base station 106. The UE 102A can apply one or more security keys when communicating on the radio bearer, in the uplink (from the UE 102A to a base station) and/or downlink (from a base station to the UE 102A) direction. In non-MBS operation, the UE 102A transmits data via the radio bearer on (i.e., within) an uplink (UL) bandwidth part (BWP) of a cell to the base station, and/or receives data via the radio bearer on a downlink (DL) BWP of the cell from the base station. The UL BWP can be an initial UL BWP or a dedicated UL BWP, and the DL BWP can be an initial DL BWP or a dedicated DL BWP. The UE 102A can receive paging, system information, public warning message(s), or a random access response on the DL BWP. In this non-MBS operation, the UE 102A can be in a connected state. Alternatively, the UE 102A can be in an idle or inactive state if the UE 102A supports small data transmission in the idle or inactive state.

In MBS operation, the UE 102A can use an MBS radio bearer (MRB) that at different times terminates at an MN (e.g., the base station 104) or an SN (e.g., the base station 106). For example, after handover or SN change, the UE 102A can use an MRB that terminates at the base station 106, which can be operating as an MN or SN. In some scenarios, a base station (e.g., the MN or SN) can transmit MBS data over unicast radio resources (i.e., the radio resources dedicated to the UE 102A) to the UE 102A via the MRB. In other scenarios, the base station (e.g., the MN or SN) can transmit MBS data over multicast radio resources (i.e., the radio resources common to the UE 102A and one or more other UEs), or a DL BWP of a cell from the base station to the UE 102A, via the MRB. The DL BWP can be an initial DL BWP, a dedicated DL BWP, or an MBS DL BWP (i.e., a DL BWP that is specific to MBS, or not for unicast).

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation of FIG. 1A includes an MBS controller 132 that is configured to manage or control transmission of MBS information received from the CN 110 or an edge server. For example, the MBS controller 132 can be configured to support radio resource control (RRC) configurations, procedures and messaging associated with MBS procedures, and/or other operations associated with those configurations and/or procedures, including a HARQ process, as discussed below. The processing hardware 130 can also include a non-MBS controller 134 that is configured to manage or control one or more RRC configurations and/or RRC procedures when the base station 104 operates as an MN or SN during a non-MBS operation.

The base station 106 includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes an MBS controller 142 and a non-MBS controller 144, which may be similar to the controllers 132 and 134, respectively, of base station 130. Although not shown in FIG. 1A, the RAN 105 can include additional base stations with processing hardware similar to the processing hardware 130 of the base station 104 and/or the processing hardware 140 of the base station 106.

The UE 102A includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes an MBS controller 152 that is configured to manage or control reception of MBS information. For example, the UE MBS controller 152 can be configured to support RRC configurations, procedures and messaging associated with MBS procedures, and/or other operations associated with those configurations and/or procedures, including a HARQ process, as discussed below. The processing hardware 150 can also include a non-MBS controller 154 configured to manage or control one or more RRC configurations and/or RRC procedures in accordance with any of the implementations discussed below, when the UE 102A communicates with an MN and/or an SN during a non-MBS operation. Although not shown in FIG. 1A. UEs 102B and 103 may include processing hardware similar to the processing hardware 150 of the UE 102A.

The CN 110 may be an evolved packet core (EPC) 111 or a fifth-generation core (5GC) 160, both of which are depicted in FIG. 1A. The base station 104 may be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. The base station 106 may be an EUTRA-NR DC (EN-DC) gNB (en-gNB) with an S1 interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104 and 106 may support an X2 or Xn interface.

Among other components, the EPC 111 can include a serving gateway (SGW) 112, a mobility management entity (MME) 114, and a packet data network gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from a UE (e.g., UE 102A or 102B) to one or more external packet data networks. e.g., an Internet network and/or an Internet Protocol (IP) Multimedia Subsystem (IMS) network. The 5GC 160 includes a user plane function (UPF) 162 and an access and mobility management (AMF) 164, and/or a session management function (SMF) 166. The UPF 162 is generally configured to transfer user-plane packets related to audio calls, video calls, Internet traffic, etc., the AMF 164 is generally configured to manage authentication, registration, paging, and other related functions, and the SMF 166 is generally configured to manage PDU sessions.

The UPF 162, AMF 164, and/or SMF 166 can be configured to support MBS. For example, the SMF 166 can be configured to manage or control MBS transport, configure the UPF 162 and/or RAN 105 for MBS flows, and/or manage or configure one or more MBS sessions or PDU sessions for MBS for a UE (e.g., UE 102A or 102B). The UPF 162 is configured to transfer MBS data packets to audio, video, Internet traffic, etc. to the RAN 105. The UPF 162 and/or SMF 166 can be configured for both non-MBS unicast service and MBS, or for MBS only.

Generally, the wireless communication system 100 may include any suitable number of base stations supporting NR cells and/or EUTRA cells. More particularly, the EPC 111 or the 5GC 160 may be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies, such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, and the base station 106 can operate as an SgNB or an Sng-eNB. The UE 102A can communicate with the base station 104 and the base station 106 via the same radio access technology (RAT), such as EUTRA or NR, or via different RATs.

When the base station 104 is an MeNB and the base station 106 is an SgNB, the UE 102A can be in EN-DC with the MeNB 104 and the SgNB 106. When the base station 104 is an Mng-eNB and the base station 106 is an SgNB, the UE 102A can be in next generation (NG) EUTRA-NR DC (NGEN-DC) with the Mng-eNB 104 and the SgNB 106. When the base station 104 is an MgNB and the base station 106 is an SgNB, the UE 102A can be in NR-NR DC (NR-DC) with the MgNB 104 and the SgNB 106. When the base station 104 is an MgNB and the base station 106 is an Sng-eNB, the UE 102A can be in NR-EUTRA DC (NE-DC) with the MgNB 104 and the Sng-eNB 106.

FIG. 1B depicts an example distributed implementation of any one or more of the base stations 104 and 106. In this implementation, the base station 104 or 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include some or all of the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 104) operates as an MN or an SN. The processing hardware can also include a physical (PHY) layer controller configured to manage or control one or more PHY layer operations or procedures.

In some implementations, the CU 172 can include one or more logical nodes (CU-CP(s) 172A) that host the control plane part of the Packet Data Convergence Protocol (PDCP) protocol of the CU 172 and/or the radio resource control (RRC) protocol of the CU 172. The CU 172 can also include one or more logical nodes (CU-UP(s) 172B) that host the user plane part of the PDCP protocol and/or service data adaptation protocol (SDAP) protocol of the CU 172. The CU-CP(s) 172A can transmit non-MBS control information and MBS control information, and the CU-UP(s) 172B can transmit non-MBS data packets and MBS data packets, as described herein.

The CU-CP(s) 172A can be connected to multiple CU-UPs 172B through the E1 interface. The CU-CP(s) 172A select the appropriate CU-UP(s) 172B for the requested services for the UE 102A. In some implementations, a single CU-UP 172B can be connected to multiple CU-CPs 172A through the E1 interface. A CU-CP 172A can be connected to one or more DUs 174s through an F1-C interface. A CU-UP 172B can be connected to one or more DUs 174 through an F1-U interface under the control of the same CU-CP 172A. In some implementations, one DU 174 can be connected to multiple CU-UPs 172B under the control of the same CU-CP 172A. In such implementations, the connectivity between a CU-UP 172B and a DU 174 is established by the CU-CP 172A using bearer context management functions.

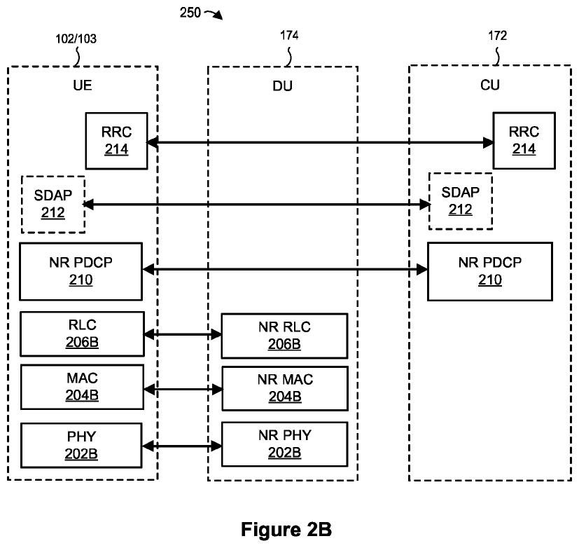

FIG. 2A illustrates, in a simplified manner, an example protocol stack 200 according to which a UE (e.g., UE 102A, 102B, or 103) can communicate with an eNB/ng-eNB or a gNB (e.g., one or more of the base stations 104, 106). In the example protocol stack 200, a PHY sublayer 202A of EUTRA provides transport channels to an EUTRA MAC sublayer 204A, which in turn provides logical channels to an EUTRA RLC sublayer 206A. The EUTRA RLC sublayer 206A in turn provides RLC channels to an EUTRA PDCP sublayer 208 and, in some cases, to an NR PDCP sublayer 210. Similarly, an NR PHY 202B provides transport channels to an NR MAC sublayer 204B, which in turn provides logical channels to an NR RLC sublayer 206B. The NR RLC sublayer 206B in turn provides RLC channels to an NR PDCP sublayer 210. The UE 102A, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102A can support layering of NR PDCP 210 over EUTRA RLC 206A, and an SDAP sublayer 212 over the NR PDCP sublayer 210. Sublayers are also referred to herein as simply “layers.”

The EUTRA PDCP sublayer 208 and the NR PDCP sublayer 210 receive packets (e.g., from an IP layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.” The packets can be MBS packets or non-MBS packets. MBS packets may include application content for an MBS service (e.g., IPv4/IPv6 multicast delivery, IPTV, software delivery over wireless, group communications. IoT applications. V2X applications, and/or emergency messages related to public safety), for example. As another example, MBS packets may include application control information for the MBS service.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 may be SDAP PDUs, IP packets, or Ethernet packets, for example.

In scenarios where the UE 102A, 102B, or 103 operates in EN-DC with the base station 104 operating as an MeNB and the base station 106 operating as an SgNB, the wireless communication system 100 can provide the UE 102A. 102B, or 103 with an MN-terminated bearer that uses EUTRA PDCP sublayer 208, or an MN-terminated bearer that uses NR PDCP sublayer 210. The wireless communication system 100 in various scenarios can also provide the UE 102A. 102B, or 103 with an SN-terminated bearer, which uses only the NR PDCP sublayer 210. The MN-terminated bearer may be an MCG bearer, a split bearer, or an MN-terminated SCG bearer. The SN-terminated bearer may be an SCG bearer, a split bearer, or an SN-terminated MCG bearer. The MN-terminated bearer may be an SRB (e.g., SRB1 or SRB2) or a DRB. The SN-terminated bearer may be an SRB or a DRB.

In some implementations, a base station (e.g., base station 104, 106) broadcasts MBS data packets via one or more MBS radio bearers (MRB(s)), and in turn the UE 102A. 102B, or 103 receives the MBS data packets via the MRB(s). The base station can include configuration(s) of the MRB(s) in multicast configuration parameters (which can also be referred to as MBS configuration parameters) described below. In some implementations, the base station broadcasts the MBS data packets via RLC sublayer 206, MAC sublayer 204, and PHY sublayer 202, and correspondingly, the UE 102A uses PHY sublayer 202. MAC sublayer 204, and RLC sublayer 206 to receive the MBS data packets. In such implementations, the base station and the UE 102A, 102B, or 103 may not use PDCP sublayer 208 and a SDAP sublayer 212 to communicate the MBS data packets. In other implementations, the base station transmits the MBS data packets via PDCP sublayer 208, RLC sublayer 206, MAC sublayer 204, and PHY sublayer 202, and correspondingly, the UE 102A, 102B, or 103 uses PHY sublayer 202, MAC sublayer 204. RLC sublayer 206 and PDCP sublayer 208 to receive the MBS data packets. In such implementations, the base station and the UE 102A. 102B, or 103 may not use a SDAP sublayer 212 to communicate the MBS data packets. In yet other implementations, the base station transmits the MBS data packets via the SDAP sublayer 212, PDCP sublayer 208, RLC sublayer 206. MAC sublayer 204, and PHY sublayer 202 and, correspondingly, the UE 102A, 102B, or 103 uses the PHY sublayer 202, MAC sublayer 204, RLC sublayer 206, PDCP sublayer 208, and SDAP sublayer 212 to receive the MBS data packets.

FIG. 2B illustrates, in a simplified manner, an example protocol stack 250 that the UE 102A. 102B, or 103 can use to communicate with a DU (e.g., DU 174) and a CU (e.g., CU 172). The radio protocol stack 200 of FIG. 2A is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) can be delegated to the DU. To support connection to a 5GC. NR PDCP 210 provides SRBs to RRC 214, and NR PDCP 210 provides DRBs to SDAP 212 and SRBs to RRC 214.

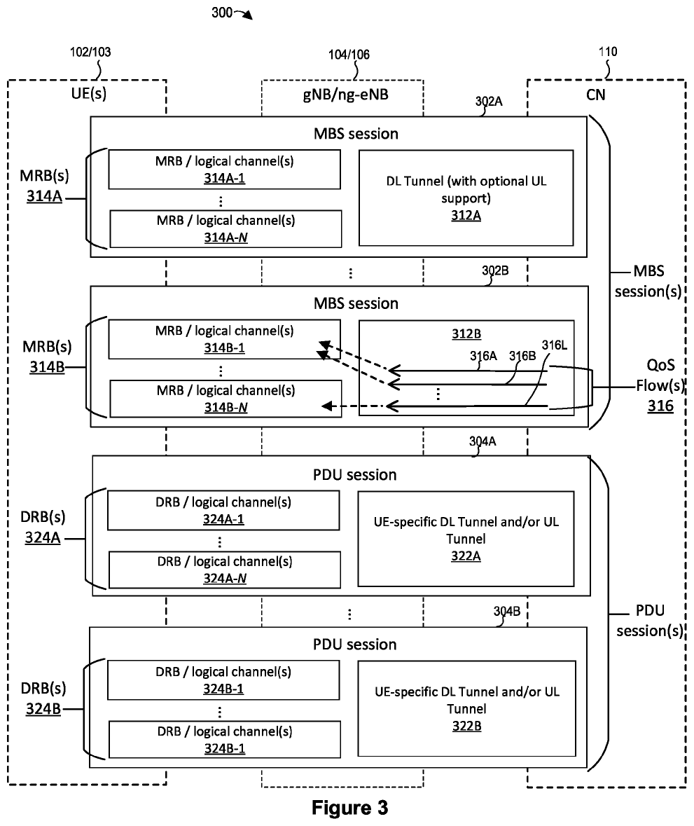

Referring to FIG. 3, an MBS session 302A can include a tunnel 312A with endpoints at the CN 110 and the base station 104/106. The MBS session 302A can correspond to a certain session ID such as a Temporary Mobile Group Identity (TMGI), for example. The MBS data can include IP packets, TCP/IP packets, UDP/IP packets. Real-Time Transport Protocol (RTP)/UDP/IP packets, or RTP/TCP/IP packets, for example.

In some cases, the CN 110 and/or the base station 104/106 configure the tunnel 312A only for MBS traffic directed from the CN 110 to the base station 104/106, and the tunnel 312A can be referred to as a downlink (DL) tunnel. In other cases, however, CN 110 and the base station 104/106 use the tunnel 312A for downlink as well as for uplink (UL) MBS traffic to support, for example, commands or service requests from the UEs. Further, because the base station 104/106 can direct MBS traffic arriving via the tunnel 312A to multiple UEs, the tunnel 312A can be referred to as a common tunnel or a common DL tunnel.

The tunnel 312A can operate at the transport layer or sublayer, e.g., on the User Datagram Protocol (UDP) protocol layered over Internet Protocol (IP). As a more specific example, the tunnel 312A can be associated with the General Packet Radio System (GPRS) Tunneling Protocol (GTP). The tunnel 312A can correspond to a certain IP address (e.g., an IP address of the base station 104/106) and a certain Tunnel Endpoint Identifier (TEID) (e.g., assigned by the base station 104/106), for example. More generally, the tunnel 312A can have any suitable transport-layer configuration. The CN 110 can specify the IP address and the TEID address in header(s) of a tunnel packet including an MBS data packet, and transmit the tunnel packet downstream to the base station 104/106 via the tunnel 312A (i.e., the header(s) can include the IP address and/or the TEID). For example, the header(s) can include an IP header and a GTP header including the IP address and the TEID, respectively. The base station 104/106 accordingly can identify data packets traveling via the tunnel 312A using the IP address and/or the TEID.

As illustrated in FIG. 3, the base station 104/106 maps traffic in the tunnel 312A to N radio bearers 314A-1, 314A-2, . . . 314A-N, which may be configured as MBS radio bearers or MRBs, where N≥1. Each MRB can correspond to a respective logical channel. As discussed above, the PDCP sublayer provides support for radio bearers such as SRBs. DRBs, and MRBs, and a EUTRA or NR MAC sublayer provides logical channels to a EUTRA or NR RLC sublayer. Each of the MRBs 314A for example can correspond to a respective MBS Traffic Channel (MTCH). The base station 104/106 and the CN 110 can also maintain another MBS session 302B, which similarly can include a tunnel 312B corresponding to MRBs 314B-1, 314B-2, . . . 314B-N, where N≥1. Each of the MRBs 314B can correspond to a respective logical channel.

The MBS traffic can include one or multiple quality-of-service (QOS) flows, for each of the tunnels 312A, 312B, etc. For example, the MBS traffic on the tunnel 312B can include a set of flows 316 including QoS flows 316A, 316B, . . . 316L. Further, a logical channel of an MRB can support a single QoS flow or multiple QoS flows. In the example configuration of FIG. 3, the base station 104/106 maps the QoS flows 316A and 316B to the MTCH of the MRB 314B-1, and the QoS flow 316L to the MTCH of the MRB 314B-N.

In various scenarios, the CN 110 can assign different types of MBS traffic to different QoS flows. A flow with a relatively high QoS value can correspond to audio packets, and a flow with a relatively low QoS value can correspond to video packets, for example. As another example, a flow with a relatively high QoS value can correspond to I-frames or complete images used in video compression, and a flow with a relatively low QoS value can correspond to P-frames or predicted pictures that include only changes to I-frames.

With continued reference to FIG. 3, the base station 104/106 and the CN 110 can maintain one or more PDU sessions to support unicast traffic between the CN 110 and particular UEs. A PDU session 304A can include a UE-specific DL tunnel and/or UE-specific UL tunnel 322A corresponding to one or more DRBs 324A, such as a DRB 324A-1, 324A-2, . . . 324-N. Each of the DRBs 324A can correspond to a respective logical channel, such as a Dedicated Traffic Channel (DTCH).

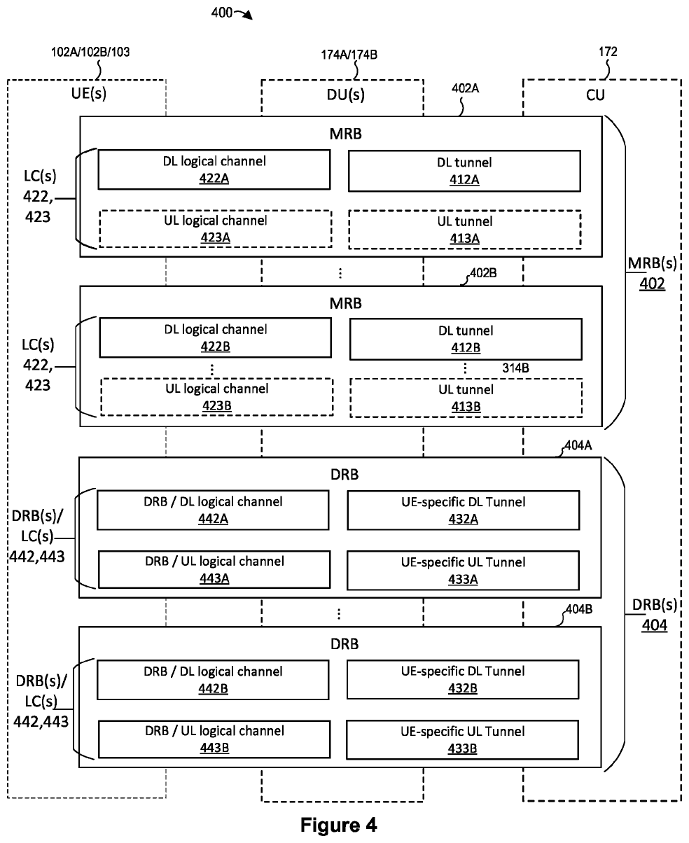

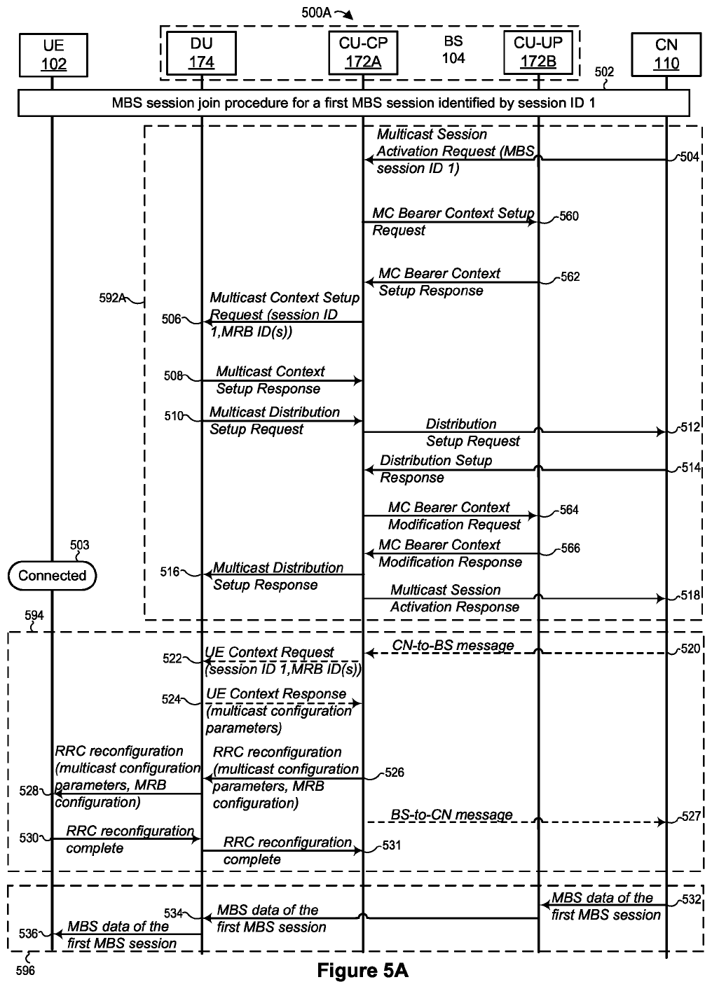

Now referring to FIG. 4, when the base station 104/106 is implemented in a distributed manner, the CU 172 and the DU 174A/174B can establish tunnels for downlink data and/or uplink data associated with an MRB or a DRB. The MRB 314A-1 discussed above can be implemented as an MRB 402A connecting the CU 172 to multiple UEs such as the UE 102A and 102B, for example. The MRB 402A can include a DL tunnel 412A connecting the CU 172 and the DU 174A/174B, and a DL logical channel 422A corresponding to the DL tunnel 412A. In particular, the DU 174A/174B can map downlink traffic received via the DL tunnel 412A to the DL logical channel 422A, which can be an MTCH or a DTCH, for example. The DL tunnel 412A can be a common DL tunnel via which the CU 172 transmits MBS data packets to multiple UEs. Alternatively, the DL tunnel 412A can be a UE-specific DL tunnel via which the CU 172 transmits MBS data packets to a particular UE.

Optionally, the MRB 402A also includes a UL tunnel 413A connecting the CU 172 and the DU 174A/174B, and a UL logical channel 423A corresponding to the UL tunnel 413A. The UL logical channel 423A can be a DTCH, for example. The DU 174A/174B can map uplink traffic received via the UL logical channel 423A to the UL tunnel 413A.

The tunnels 412A and 413A can operate at the transport layer or sublayer of the F1-U interface. As a more specific example, the CU 172 and the DU 174A/174B can utilize an F1-U for user-plane traffic, and the tunnels 412A and 413A can be associated with the GTP-U protocol layered over UDP/IP, where IP is layered over suitable data link and physical (PHY) layers. Further, the MRB(s) 402 and/or the DRB(s) 404 in at least some of the cases additionally support control-plane traffic. More particularly, the CU 172 and the DU 174A/174B can exchange F1-AP messages over an F1-C interface that relies on a Stream Control Transmission Protocol (SCTP) layered over IP, where IP is layered over suitable data link and PHY layers similar to F1-U.

Similarly, an MRB 402B can include a DL tunnel 412B and, optionally, an UL tunnel 413B. The DL tunnel 412B can correspond to a DL logical channel 422B, and the UL tunnel 413B can correspond to the UL logical channel 423B.

The CU 172 in some cases uses a DRB 404A to transmit MBS data packets or unicast data packets associated with a PDU session, to a particular UE (e.g., the UE 102A or the UE 102B). The DRB 404A can include a UE-specific DL tunnel 432A connecting the CU 172 and the DU 174A/174B, and a DL logical channel 442A corresponding to the DL tunnel 432A. In particular, the DU 174A/174B can map downlink traffic received via the DL tunnel 432A to the DL logical channel 442A, which can be a DTCH, for example. The DRB 404A further includes a UE-specific UL tunnel 433A connecting the CU 172 and the DU 174A/174B, and a UL logical channel 443A corresponding to the UL tunnel 433A. The UL logical channel 443A can be a PUSCH, for example. The DU 174A/174B can map uplink traffic received via the UL logical channel 443A to the UL tunnel 433A.

Similarly, a DRB 404B can include a UE-specific DL tunnel 432B corresponding to a DL logical channel 442B, and a UE-specific UL tunnel 433B corresponding to a UL logical channel 443B.

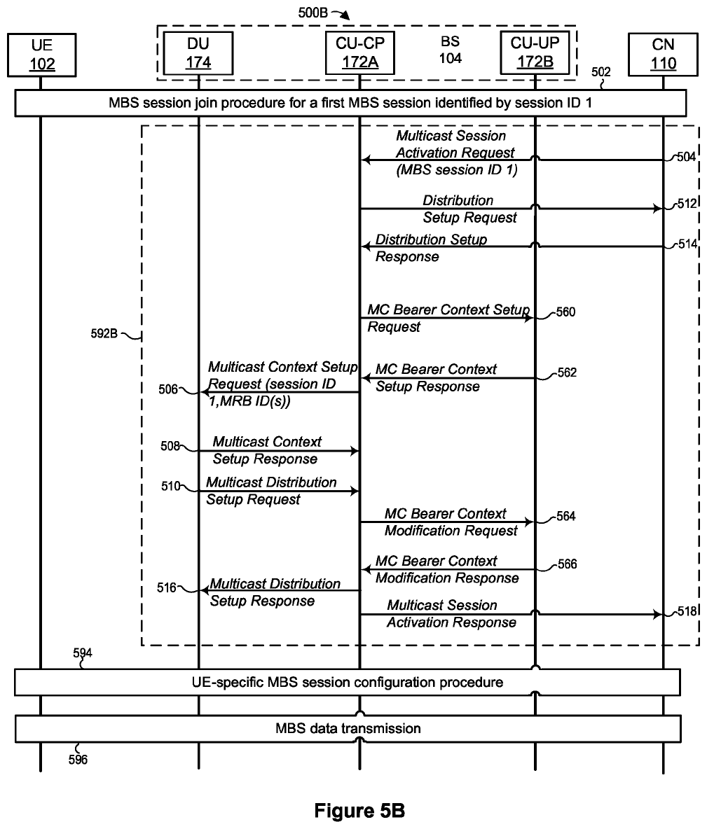

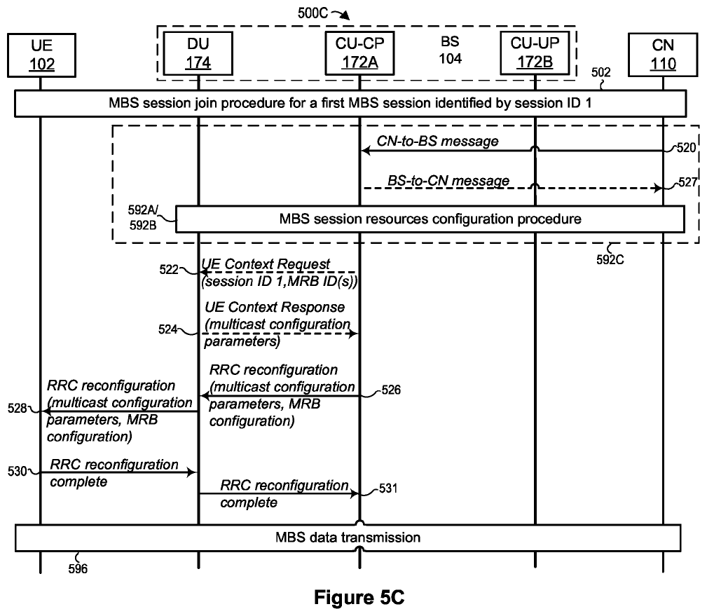

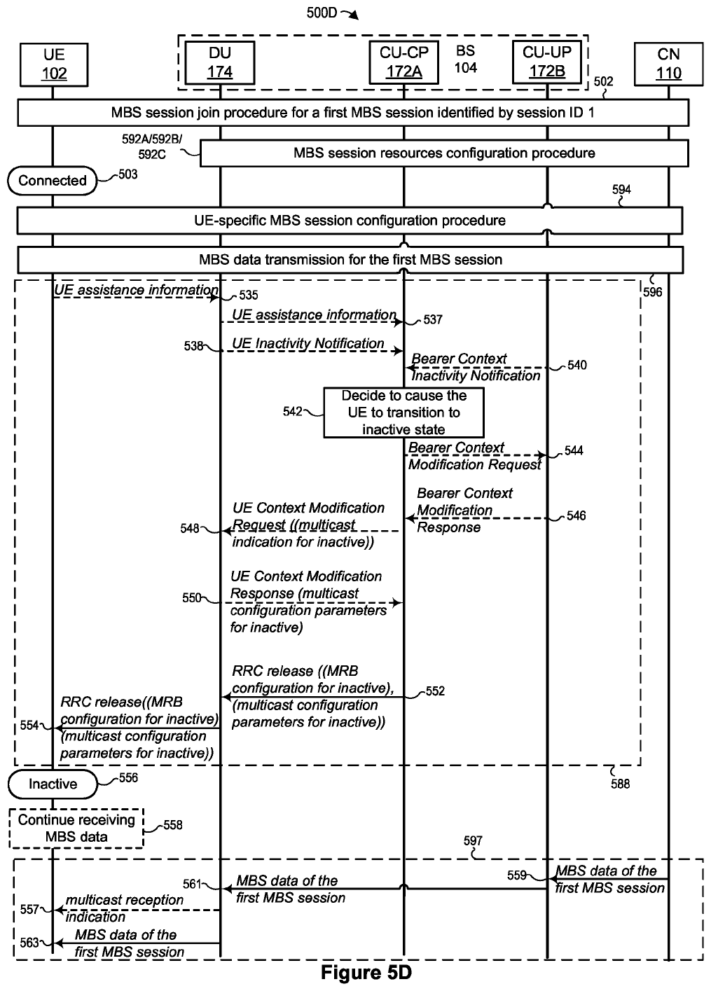

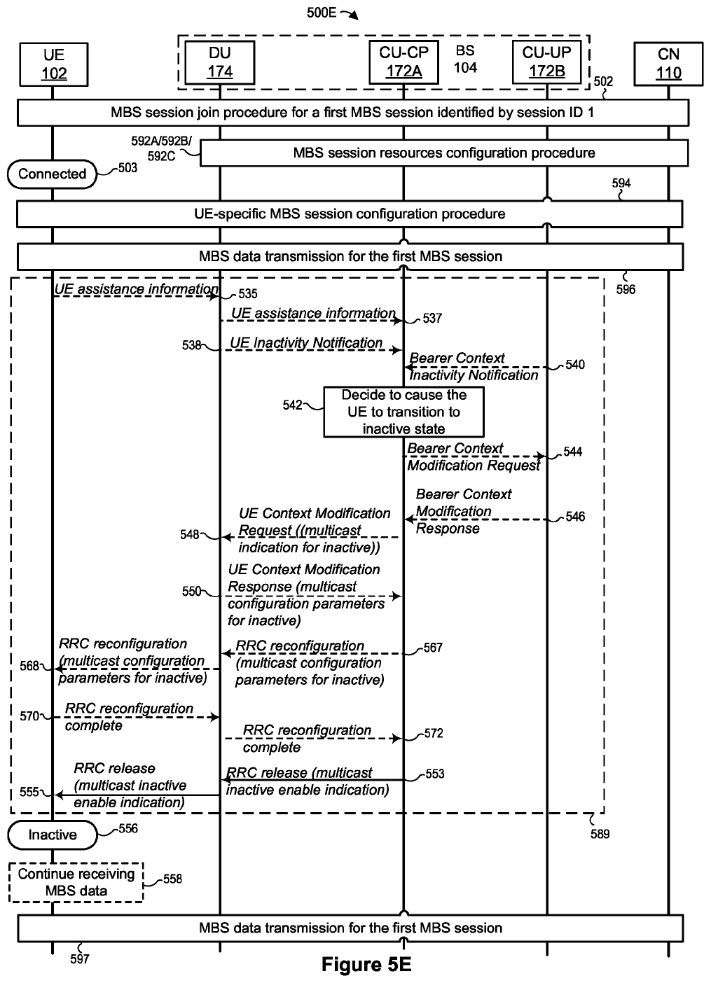

Next, several example scenarios in which a UE and/or a RAN perform the techniques of this disclosure for supporting MBS for the UE operating in a connected state and/or inactive state are discussed with reference to FIGS. 5A-5E. In the following description, the connected state, inactive state and idle state can be RRC_CONNECTED state, RRC_INACITVE state and RRC_IDLE state, respectively, for example.

FIG. 5A illustrates an example scenario 500A of establishing an MBS session. The base station 104 includes a DU 174, CU-CP 172A, and CU-UP 172B. Note, the scenario 500A can also apply to an integrated CU (e.g., a CU which is not split into CP and UP function nodes).

The UE 102 (e.g., UE 102A of FIG. 1A) initially performs 502 an MBS session join procedure with the CN 110 via the base station 104 to join a first MBS session. In some implementations, the MBS session join procedure does not involve the CU-UP 172B. In further implementations, the UE 102 subsequently performs an additional one or more MBS join procedures, and event 502 accordingly is a first one of multiple MBS join procedures. In some implementations, because the base station 104 configures a common DL tunnel for MBS traffic (rather than a UE-specific tunnel as discussed below), the procedures 502 and 592A occur in either order. In other words, in such implementations, the base station 104 configures a common DL tunnel before any UE joins the first MBS session.

In some implementations, the UE 102 performs 502 the MBS session join procedure while operating in a connected state. In some scenarios or implementations, if the first MBS session has not started yet, the CU-CP 172A transitions the UE 102 to an inactive state or idle state after the MBS session join procedure to save battery power of the UE 102. For example, the CU-CP 172A can transmit an RRC release message to the UE 102 to transition the UE 102 to the inactive state or idle state from the connected. The UE 102 transitions to the inactive state or idle state in response to the RRC release message. In some implementations, for the inactive state, the UE 102 later initiates an RRC connection resume procedure with the CU-CP 172A via the DU 174 to transition to the connected state. In response to the initiation, the UE 102 transmits an RRC resume request message to the CU-CP 172A via the DU 174 and receives an RRC resume message from the CU-CP 172A via the DU 174. In response, the UE 102 transitions 503 to the connected state and transmits an RRC resume complete message to the CU-CP 172A via the DU 174. In further implementations, for the idle state, the UE 102 later initiates an RRC connection establishment procedure with the CU-CP 172A via the DU 174 to transition to the connected state. In response to the initiation, the UE 102 transmits an RRC setup request message to the CU-CP 172A via the DU 174 and receives an RRC setup message from the CU-CP 172A via the DU 174. In response, the UE 102 transitions 503 to the connected state and transmits an RRC setup complete message to the CU-CP 172A via the DU 174.

Otherwise, if the first MBS session has started, is starting, or is going to start, the CU-CP 172A causes the UE 102 to remain in the connected state.

While the UE 102 operates in the connected state, the UE 102 monitors a PDCCH with a cell radio network temporary identifier (C-RNTI) to communicate unicast data with the DU 174. In some implementations, the unicast data includes data associated with SRB(s) and/or DRB(s). In one implementation, the unicast data includes the following messages for the MBS session join procedure and messages of events 528 and 530 described below. In some implementations, the unicast data also includes unicast MBS data (e.g., at event 536). In further implementations, the unicast data excludes multicast MBS data (e.g., at event 536). In some implementations, when the UE 102 receives a DCI and a scrambled CRC on a PDCCH, the UE 102 uses the C-RNTI and DCI to verify the CRC. If the UE 102 verifies that the CRC is valid and the DCI includes an UL grant, the UE 102 transmits a UL transmission, including unicast data, to the DU 174 in accordance with the UL grant. If the UE 102 verifies that the CRC is valid and the DCI includes a DL assignment, the UE 102 receives a DL transmission, including unicast data, from the DU 174 in accordance with the DL assignment.

In some implementations, to perform the MBS session join procedure, the UE 102 sends an MBS session join request message to the CN 110 via the base station 104. In some such implementations, in response, the CN 110 sends an MBS session join response message to the UE 102 via the base station 104 to grant the UE 102 access to the first MBS session. In some implementations, the UE 102 includes a first MBS session ID (e.g., MBS Session ID 1) for the first MBS session in the MBS session join request message. The CN 110 in some cases includes the first MBS session ID in the MBS session join response message. In some implementations, the UE 102 sends an MBS session join complete message to the CN 110 via the base station 104 in response to the MBS session join response message.

In some implementations, the MBS session join request message, MBS session join response message, and MBS session join complete message are session initiation protocol (SIP) messages. In other implementations, the MBS session join request message, MBS session join response message, and MBS session join complete message are NAS messages such as 5G mobility management (5GMM) messages or 5G session management messages (5GSM). In some implementations, for messages such as 5GSM messages, the UE 102 transmits, to the CN 110 via the base station 104, a first UL container message including the MBS session join request message; the CN 110 transmits, to the UE 102 via the base station 104, a DL container message including the MBS session join response message; and the UE 102 transmits, to the CN 110 via the base station 104, a second UL container message including the MBS session join complete message. In some implementations, such container messages are messages similar to or are 5GMM messages.

In some implementations, the MBS session join request message, MBS session join response, and MBS session join complete message are a PDU Session Modification Request message, a PDU Session Modification Command message, and a PDU Session Modification Complete message, respectively. To simplify the following description, the terms MBS session join request message, MBS session join response message, and/or MBS session join complete message can represent either the respective container messages, or the respective messages without containers.

In some implementations, the UE 102 performs a PDU session establishment procedure with the CN 110 via the base station 104 to establish a PDU session in order to perform the MBS session join procedure. In further implementations, during the PDU session establishment procedure, the UE 102 communicates a PDU session ID for the PDU session with the CN 110 via the base station 104.

In some implementations, before, during, or after the first MBS session join procedure (event 502), the CN 110 sends 504 a first CN-to-BS message (e.g., Multicast Session Activation Request message), including the first MBS session ID, to the CU-CP 172A to request the CU-CP 172A to configure or activate resources for the first MBS session (e.g., a multicast session).

In some implementations, the CN 110 includes first MBS quality of service (QOS) flow configuration(s) for the first MBS session in the first CN-to-BS message. In some implementations, the first MBS QoS flow configuration(s) configure MBS QoS flow(s) 1, . . . , M associated with the first MBS session, where M is an integer and larger than zero. In some implementations, the first MBS QoS flow configuration(s) include MBS QoS flow identifier(s) 1, . . . , M and/or MBS QOS flow level QoS parameter(s) 1, . . . , M for the MBS QoS flow(s) 1, . . . , M associated with the first MBS session. In some implementations, each of the MBS QoS flow configuration(s) 1, . . . , M includes an MBS QOS flow identifier and MBS QOS flow level QoS parameters for a particular MBS QoS flow.

In other implementations, the CN 110 does not include MBS QOS flow configuration(s) for the first MBS session in the first CN-to-BS message. Thus, the CU-CP 172A generates the second MBS QoS flow configuration(s) based on preconfigured MBS QoS flow configuration(s). For example, the second MBS QoS flow configuration(s) are the same as the preconfigured MBS QoS flow configuration(s). In another example, the second MBS QoS flow configuration(s) are similar to the preconfigured MBS QoS flow configuration(s). In some implementations, the CU-CP 172A are preconfigured with the preconfigured MBS QoS flow configuration(s) before receiving the first CN-to-BS message. In other implementations, the CU-CP 172A receives the preconfigured MBS QoS flow configuration(s) from an Operations. Administration and Maintenance (OAM) node before receiving the first CN-to-BS message. Examples or implementations described for the first MBS QoS flow configuration(s) can apply to the preconfigured MBS QoS flow configuration(s).

In yet other implementations, the CN 110 sends, to the CU-CP 172A, an additional CN-to-BS message (e.g., a Multicast Session Update Request message), including the first MBS session ID and the first MBS QoS flow configuration(s), after sending 504 the first CN-to-BS message. After receiving the additional CN-to-BS message, the CU-CP 172A sends 560 the first CP-to-UP message and 506 the first CU-to-DU message to the CU-UP 172B and DU 174, respectively. In other words, the CU-CP 172A delays sending the first CP-to-UP message and first CU-to-DU message (e.g., delays performing the MC Bearer Context Setup procedure and the Multicast Context Setup procedure) until receiving the first MBS QoS flow configuration(s) or the additional CN-to-BS message. In some such implementations, the CU-CP 172A sends an additional BS-to-CN message (e.g., a Multicast Session Update Response message) to the CN 110 in response to the additional CN-to-BS message.

In some implementations, the CU-CP 172A sends, to the CN 110, the additional BS-to-CN message upon receiving 504 the first CN-to-BS message. In other implementations, the CU-CP 172A sends 518 the second BS-to-CN message to the CN 110 before or after receiving 514 the second CN-to-BS message, receiving 566 the second UP-to-CP message (e.g., as described below), or transmitting 516 the second CU-to-DU message. In some implementations, the CU-CP 172A sends 518, to the CN 110, the second BS-to-CN message before receiving the additional CN-to-BS message or sending the additional BS-to-CN message. In other implementations, the CU-CP 172A sends 518 the second BS-to-CN message to the CN 110 after receiving the additional CN-to-BS message or sending the additional BS-to-CN message.

In some implementations, the CN 110 includes the first slice information in a fourth CN-to-BS message. In some such cases, the CN 110 does not include the first slice information in the first CN-to-BS message. In some implementations, the CN 110 includes the first MBS area information in the additional CN-to-BS message. In some such cases, the CN 110 does not include the first MBS area information in the first CN-to-BS message.

In some implementations, the CN 110 includes, in the first CN-to-BS message, first slice information indicating a network slice used for the first MBS session. For example, in some implementations, the first slice information is Single Network Slice Selection Assistance Information (S-NSSAI) identifying the particular network slice. In other implementations, the CN 110 does not include slice information (e.g., S-NSSAI) in the first CN-to-BS message. In some such cases, a default network slice is used for the first MBS session.

In some implementations, the CN 110 includes, in the first CN-to-BS message, first MBS area information (e.g., MBS Service Area IE) configuring or indicating MBS area(s) for the first MBS session. In cases where the first MBS session is a location-dependent multicast session, the first MBS area information includes one or more tuples of {MBS Area Session ID IE, MBS Service Area Information IE}. In cases where the first MBS session is a location-independent multicast session, the first MBS are information includes an MBS Service Area Information IE. An MBS Service Area Information IE in the first MBS area information includes a list of cell identity/identities and/or a list of tracking area identity/identities (TAI(s)). In some implementations, the cell identity/identities is/are cell global identity/identities (CGI(s)). In other implementations, the CN 110 does not include MBS area information (e.g., MBS Service Area IE) in the first CN-to-BS message.

After receiving 504 the first CN-to-BS message, the CU-CP 172A sends 560 a first CP-to-UP message (e.g., MC Bearer Context Setup Request message) to the CU-UP 172B to request resources for the first MBS session. In some implementations, the CU-CP 172A determines to configure one or more MRBs for the first MBS session or the MBS QoS flow(s) 1, . . . , M. In response to the determination, the CU-CP 172A generates an MRB setup configuration for requesting resources for the one or more MRBs. The CU-CP 172A includes the first MBS session ID, the MRB setup configuration, and/or second MBS QoS flow configuration(s) for the first MBS session in the first CP-to-UP message. In some implementations, the second MBS QoS flow configuration(s) include QoS parameters for the MBS QOS flow(s) associated with the first MBS session. In some implementations, the QoS parameters include, for example 5G QoS identifier(s) (5QI(s)), priority level(s), packet delay budget(s), packet error rate(s), averaging window(s), and/or maximum data burst volume(s).

In some implementations, the CU-CP 172A includes the second MBS QoS flow configuration(s) (e.g., MBS QOS flows Information to be Setup and/or MRB QOS IE(s), or QoS-Flow-QoS-Parameter-List and/or QoSFlowLevelQoSParameters IE(s)) in the MRB setup configuration (e.g., MCMRBSetupConfiguration IE). In some implementations, the MRB setup configuration includes one or more MRB setup configuration item(s) (e.g., MCMRBSetupConfiguration-Item IE(s)). In some implementations, each of the MRB setup configuration items includes an MRB ID, MRB configuration parameters (e.g., a PDCP configuration and/or an SDAP configuration), and/or particular one(s) of the second MBS QoS flow configuration(s) for a particular MRB. In some implementations, the PDCP configuration includes a UL PDCP sequence number size configuration, a DL PDCP sequence number size configuration, and/or an RLC mode configuration (e.g., acknowledged mode or unacknowledged mode). In some implementations, the SDAP configuration includes a default DRB configuration (e.g., DefaultDRB IE), an SDAP UL header configuration (e.g., SDAP-Header-UL), and/or an SDAP DL header configuration (e.g., SDAP-Header-DL).

In some implementations, the second MBS QoS flow configuration(s) include QoS parameters required for each of the MBS QoS flow(s) associated with the MRB(s). In some implementations, the second MBS QoS flow configuration(s) include MBS QoS flow identifier(s) 1, . . . , M and/or MBS QoS flow level QoS parameter(s) 1, . . . , M for the MBS QoS flow(s) 1, . . . , M associated with the first MBS session. The MBS QOS flow identifier(s) 1, . . . , M identify the MBS QoS flow(s) 1, . . . , M. For example, the MRB setup configuration includes MRB setup configuration item(s) 1, . . . , N for the MRB(s) 1, . . . , N, respectively, where Nis an integer and larger than zero. In some implementations, in the MRB setup configuration, the CU-CP 172A configures mapping(s) or association(s) between the MBS QoS flow(s) 1, . . . , M and MRB(s) 1, . . . , N, where N is an integer and M≥N>0. In some implementations, the CU-CP 172A associates or maps a particular QoS flow to a particular MRB. In other words, the CU-CP 172A refrains from associating or mapping a particular QoS flow to two MRBs. In some implementations, the MRB setup configuration item X includes MRB ID X, PDCP configuration X, SDAP configuration X, and/or particular MBS QoS flow configuration(s) of the second MBS QoS flow configuration(s), for MRB X of the MRB(s) 1, . . . , N, where 1≤X≤N.

Example 1 of the MRB setup configuration:

MCMRBSctupConfiguration ::= SEQUENCE (SIZE(1..maxnoofMRBs)) OF MCMRBSetupConfiguration-Item
MCMRBSetupConfiguration-Item ::= SEQUENCE {

| mrb-ID | MRB-ID, | |
|---|---|---|
| sdap-config | SDAP-Configuration, | |
| mbs-pdcp-config | PDCP-Configuration, | |
| qoS-Flow-QoS-Parameter-List | QoS-Flow-QoS-Parameter-List, | |
| qoSFlowLevelQoSParameters | QoSFlowLevelQoSParameters | OPTIONAL, |

| | |
|---|---|
| iE-Extensions | ProtocolExtensionContainer { {MCMRBSetupConfiguration-Item-ExtIEs} } OPTIONAL, |

...
}

Example 2 of the MRB setup configuration (i.e., SDAP-Configuration is omitted):

MCMRBSetupConfiguration ::= SEQUENCE (SIZE(1..maxnoofMRBs)) OF MCMRBSetupConfiguration-Item
MCMRBSetupConfiguration-Item ::= SEQUENCE {

| mrb-ID | MRB-ID, | |
|---|---|---|
| mbs-pdcp-config | PDCP-Configuration, | |
| qoS-Flow-QoS-Parameter-List | QoS-Flow-QoS-Parameter-List, | |
| qoSFlowLevelQoSParameters | QoSFlowLevelQoSParameters | OPTIONAL, |

| | |
|---|---|
| iE-Extensions | ProtocolExtensionContainer { {MCMRBSetupConfiguration-Item-ExtIEs} } OPTIONAL, |

...
}

In the example 2, the CU-CP 172A omits the SDAP-Configuration from the MCMRBSetupConfiguration-Item.

In some implementations, the CU-CP 172A generates the second MBS QoS flow configuration(s) based on the first MBS QoS flow configuration(s). For example, the second MBS QoS flow configuration(s) are the same as the first MBS QoS flow configuration(s). In another example, the second MBS QOS flow configuration(s) are similar to the first MBS QoS flow configuration(s).

In some cases where the CU-CP 172A receives the first slice information from the CN 110 (e.g., in the first CN-to-BS message), the CU-CP 172A includes the first slice information in the first CP-to-UP message to indicate that the particular network slice indicated by the first slice information is used for the first MBS session. In some cases where the CU-CP 172A does not receive slice information from the CN 110 (e.g., in the first CN-to-BS message), the CU-CP 172A includes preconfigured slice information in the first CP-to-UP message to indicate a particular network slice is used for the first MBS session. Alternatively, the CU-CP 172A in such cases omits slice information from the first CP-to-UP message to indicate a default network slice is used for the first MBS session.

In some cases where the CU-CP 172A receives the first MBS area information from the CN 110 (e.g., in the first CN-to-BS message), the CU-CP 172A includes the first MBS area information in the first CP-to-UP message. In some cases where the CU-CP 172A does not receive MBS area information from the CN 110 (e.g., in the first CN-to-BS message), the CU-CP 172A includes preconfigured MBS area information in the first CP-to-UP message. Alternatively, the CU-CP 172A in such cases omits MBS area information from the first CP-to-UP message. In further cases where the CU-CP 172A receives the first MBS area information from the CN 110, the CU-CP 172A retrieves an MBS Area Session ID from the first MBS area information and includes the MBS Area Session ID in the first CP-to-UP message. In some such cases, the CU-CP 172A refrains from including an MBS Service Area Information IE in the first CP-to-UP message. In further cases where the CU-CP 172A does not receive MBS area information from the CN 110, the CU-CP 172A includes preconfigured MBS Area Session ID in the first CP-to-UP message. Alternatively, the CU-CP 172A in such cases omits MBS Area Session ID from the first CP-to-UP message.

In response to the first CP-to-UP message, the CU-UP 172B establishes or configures resources for the MRB(s) and sends 562 a first UP-to-CP message (e.g., MC Bearer Context Setup Response message). In some implementations, the CU-UP 172B configures resources for each of the MRB(s) based on the corresponding MRB configuration parameters and/or particular configuration(s) of the second MBS QoS flow configuration(s). In some implementations, the CU-UP 172B configures resources for the MRB(s), MBS QoS flow(s), and/or first MBS session based on the first slice information. In some implementations, the CU-UP 172B establishes and/or configures PDCP entity/entities 1, . . . , N in accordance with the PDCP configuration(s) 1, . . . , N for the MRB(s) or MRB ID(s) 1, . . . , N. In other implementations, for each of PDCP configuration(s) 1, . . . , N, the CU-UP 172B ignores or discards a portion of the PDCP configuration and establishes and/or configures a PDCP entity in accordance with the rest of the PDCP configuration. In one implementation, the CU-UP 172B ignores or discards the UL PDCP sequence number size configuration and establishes and/or configures a PDCP entity in accordance with the DL PDCP sequence number size configuration and/or RLC mode. In further implementations, the CU-UP 172B ignores or discards the UL PDCP sequence number size configuration and the RLC mode, and establishes and/or configures a PDCP entity in accordance with the DL PDCP sequence number size configuration.

In some implementations, the CU-UP 172B establishes and/or configures SDAP entity/entities 1, . . . , N in accordance with the SDAP configuration(s) 1, . . . , N for the MRB(s) or MRB ID(s) 1, . . . , N. In other implementations, for each of SDAP configuration(s) 1, . . . , N, the CU-UP 172B ignores or discards a portion of the SDAP configuration and establishes and/or configures an SDAP entity in accordance with the rest of the SDAP configuration. In one implementation, the CU-UP 172B ignores or discards the default DRB configuration and SDAP UL header configuration, and establishes and/or configures an SDAP entity in accordance with the SDAP DL header configuration. In further implementations, the CU-UP 172B ignores or discards the default DRB configuration, and establishes and/or configures an SDAP entity in accordance with the SDAP UL header configuration and SDAP DL header configuration. In yet other implementations, the CU-UP 172B ignores or discards the entire SDAP configuration because the CU-UP 172B determines not to use SDAP to transmit MBS data of the first MBS session.

In some implementations, the CU-UP 172B includes, in the first UP-to-CP message, a first CU transport layer configuration to configure a common CN-to-BS DL tunnel for the first MBS session configuration. In some implementations, the first CU transport layer configuration includes a CU transport layer address (e.g., an IP address and/or a TEID) to identify a first common CN-to-BS DL tunnel. In other implementations, the first CU transport layer configuration is an MC Bearer Context NG-U TNL Info at NG-RAN IE. In some implementations, the CU-CP 172A includes a first ID (e.g., a CU-CP MBS E1AP ID) in the first CP-to-UP message to identify the first MBS session on an E1 interface between the CU-CP 172A and CU-UP 172B. In some implementations, the CU-UP 172B includes a first ID (e.g., a CU-UP MBS E1AP ID) in the first UP-to-CP message to identify the first MBS session on an E1 interface between the CU-CP 172A and CU-UP 172B. Depending on the implementation, the CU-UP 172B includes the first ID (e.g., the CU-CP MBS E1AP ID) in the first UP-to-CP message.

The events 560 and 562 are collectively referred to in FIG. 5A as an MC Bearer Context Setup procedure.

After (e.g., in response to) receiving 504 the first CN-to-BS message, the CU-CP 172A sends 506 a first CU-to-DU message (e.g., a Multicast Context Setup Request message) to the DU 174 to request a set-up for a multicast context and/or a common DL tunnel for the first MBS session. The CU-CP 172A determines to configure one or more MRBs for the first MBS session or the MBS QoS flow(s) 1, . . . , M. In response to the determination, the CU-CP 172A generates a configuration for an MRB to be setup for requesting resources for the one or more MRBs. In some implementations, the first CU-to-DU message includes the first MBS session ID, the configuration for the MRB to be setup, and/or third MBS QoS flow configuration(s) for the first MBS session. In some implementations, the CU-CP 172A includes the first slice information in the first CU-to-DU message to indicate that the particular network slice indicated by the first slice information is used for the first MBS session. In some implementations, the configuration for the MRB to be setup includes MRB ID(s), each identifying an MRB, and the DU 174 configures resources (e.g., PHY, MAC and/or RLC resources) for the MRB(s). The MRB ID(s) included in the first CU-to-DU message is/are the same as the MRB ID(s) included in the first CP-to-UP message. For example, the configuration for the MRB to be setup includes the MRB ID(s) 1, . . . , N for the MRB(s) 1, . . . , N, respectively. The third MBS QoS flow configuration(s) include QoS parameters required for the MBS QoS flow(s) associated with the first MBS session. In some implementations, the third MBS QoS flow configuration(s) include MBS QoS flow identifier(s) 1, . . . , M and/or MBS QOS flow level QoS parameter(s) 1, . . . , M for the MBS QoS flow(s) 1, . . . , M associated with the first MBS session. The MBS QOS flow identifier(s) 1, . . . , M identify the MBS QoS flow(s) 1, . . . , M, respectively. In some implementations, in the configuration for the MRB to be setup, the CU-CP 172A configures mapping(s) or association(s) between the MBS QoS flow(s) and MRB(s). For example, the configuration for the MRB to be setup includes setup configuration item(s) 1, . . . , N for the MRB(s) 1, . . . , N, respectively. In some implementations, the setup configuration item Y includes MRB ID Y and particular MBS QoS flow configuration(s) of the third MBS QoS flow configuration(s), for MRB Y of the MRB(s) 1, . . . , N, where 1≤Y≤N. In some implementations, the CU-CP 172A generates the third MBS QoS flow configuration(s) based on the first MBS QoS flow configuration(s). For example, the third MBS QoS flow configuration(s) are the same as the first MBS QoS flow configuration(s). In another example, the third MBS QoS flow configuration(s) are similar to the first MBS QoS flow configuration(s). In some implementations, the CU-CP 172A includes an ID (e.g., a CU MBS F1AP ID) in the first CU-to-DU message to identify the first MBS session on an F1 interface between the CU-CP 172A and DU 174.

In some cases where the CU-CP 172A receives the first slice information (e.g., S-NSSAI) associated with the first MBS session from the CN 110 (e.g., in the first CN-to-BS message), the CU-CP 172A includes the first slice information in the first CU-to-DU message to indicate the particular network slice is used for the first MBS session. In cases where the CU-CP 172A does not receive slice information (e.g., S-NSSAI) associated with the first MBS session from the CN 110 (e.g., in the first CN-to-BS message), the CU-CP 172A includes preconfigured slice information in the first CU-to-DU message. Alternatively, the CU-CP 172A in such cases omit slice information in the first CP-to-UP message.

In some cases where the CU-CP 172A receives the first MBS area information from the CN 110 (e.g., in the first CN-to-BS message), the CU-CP 172A includes the first MBS area information in the first CU-to-DU message. In some cases where the CU-CP 172A does not receive MBS area information from the CN 110 (e.g., in the first CN-to-BS message), the CU-CP 172A includes preconfigured MBS area information in the first CU-to-DU message. Alternatively, the CU-CP 172A in such cases omits MBS area information from the first CU-to-DU message. In further cases where the CU-CP 172A receives the first MBS area information from the CN 110, the CU-CP 172A retrieves an MBS Area Session ID from the first MBS area information and includes the MBS Area Session ID in the first CU-to-DU message. In further cases where the CU-CP 172A does not receive MBS area information from the CN 110, the CU-CP 172A includes a preconfigured MBS Area Session ID in the first CU-to-DU message. Alternatively, the CU-CP 172A in such cases omits MBS Area Session ID from the first CU-to-DU message.

In response to receiving 506 the first CU-to-DU message, the DU 174 establishes or configures resources (e.g., a multicast context and/or PHY, MAC, RLC, and/or tunnel resources) for the MRB(s) and sends 508 a first DU-to-CU message (e.g., a Multicast Context Setup Response message) to the CU-CP 172A. In some implementations, the DU 174 establishes and/or configures a MAC entity for the MRB(s). In further implementations, the DU 174 establishes and/or configures RLC entity/entities 1, . . . , N for the MRB(s) or MRB ID(s) 1, . . . , N, respectively. In some implementations, the DU 174 includes, in the first DU-to-CU message, a first DU transport layer configuration to configure a common CU-to-DU DL tunnel for the first MBS session (e.g., for an MRB identified by one of the MRB ID(s)). Depending on the implementation, the DU 174 includes, in the first DU-to-CU message, additional DU transport layer configuration(s) to configure additional common CU-to-DU DL tunnel(s) for additional MRB(s) identified by additional MRB ID(s) of the MRB IDs. In some implementations, the DU 174 includes, in the first DU-to-CL′ message, the MRB ID(s) associated with the first DU transport layer configuration and/or the additional DU transport layer configuration(s). For example, each of the MRB ID(s) is associated with a particular DU transport layer configuration. In some implementations, each of the first DU transport layer configuration and/or the additional DU transport layer configuration(s) includes a DU transport layer address (e.g., an IP address and/or a TEID). In further implementations, each of the first DU transport layer configuration and/or the additional DU transport layer configuration(s) are an MRB F1-U TNL Info at DU IE.

The events 506 and 508 are collectively referred to in FIG. 5A as a Multicast Context Setup procedure. In some implementations, the Multicast Context Setup procedure and the MC Bearer Context Setup procedure occur in parallel. In other implementations, the Multicast Context Setup procedure occur after the MC Bearer Context Setup procedure or vice versa.

In some implementations, the DU 174 transmits 510 a second DU-to-CU message (e.g., Multicast Distribution Setup Request message) to the CU-CP 172A after receiving 506 the first CU-to-DU message or transmitting 508 the first DU-to-CU message. In some implementations, the DU 174 includes the first DU transport layer configuration and/or the additional DL transport layer configuration(s) in the second DU-to-CU message instead of the first DU-to-CU message. In some implementations, the DU 174 includes, in the second DU-to-CU message, the MRB ID(s) associated with the first DU transport layer configuration and/or the additional DU transport layer configuration(s) instead of the first DU-to-CU message. Thus, the first DU-to-CU message does not include a DU transport layer configuration. In some implementations, the CU-CP 172A transmits 516 a second CU-to-DU message (e.g., Multicast Distribution Setup Response message) to the DU 174 in response to the second DU-to-CU message. The events 510 and 516 are collectively referred to in FIG. 5A as a Multicast Distribution Setup procedure.

After receiving 504 the first CN-to-BS message, receiving 562 the first UP-to-CP message, receiving 508 the first DU-to-CU message, or receiving 510 the second DU-to-CU message, the CU-CP 172A transmits 512 a first BS-to-CN message (e.g., a Distribution Setup Request message) to the CN 110. In some implementations, the CU-CP 172A transmits 512 the first BS-to-CN message to the CN 110 before receiving 508 the first DU-to-CU message or receiving 510 the second DU-to-CU message. In further implementations, the CU-CP 172A includes the first CU transport layer configuration in the first BS-to-CN message. Thus, the CN 110 sends MBS data to the CU-UP 172B via the first common CN-to-BS DL tunnel as described for event 532. In some implementations, the CU-CP 172A includes the first MBS session ID in the first BS-to-CN message. In further implementations, the CN 110 sends 514 a second CN-to-BS message (e.g., a Distribution Setup Response message) to the CU-CP 172A in response to the first BS-to-CN message. In some implementations, the CN 110 includes a first CN transport layer configuration in the second CN-to-BS message. The first CN transport layer configuration includes at least one CN transport layer address (e.g., IP address(s)) to identify the first common CN-to-BS DL tunnel. In some implementations, the at least one transport layer address includes an IP source address and/or an IP multicast address. In some implementations, the first CN transport layer configuration includes a TEID at/of the CN 110. In further implementations, the CN 110 includes fourth MBS QoS flow configuration(s) for the first MBS session in the second CN-to-BS message. In some implementations, the fourth MBS QoS flow configuration(s) are similar to the first MBS QoS flow configuration(s).

After receiving 514 the second CN-to-BS message, the CU-CP 172A sends 564 a second CP-to-UP message (e.g., MC Bearer Context Modification Request message) to the CU-UP 172B. In some implementations, the CU-CP 172A includes the MRB ID(s), first DU transport layer configuration, additional DU transport layer configuration(s), and/or first CN transport layer configuration in the second CP-to-UP message. In response to the second CP-to-UP message of event 564, the CU-UP 172B sends 566 a second UP-to-CP message (e.g., MC Bearer Context Modification Response message). In some implementations, the CU-UP 172B includes the MRB ID(s) and/or a second CU transport layer configuration in the second UP-to-CP message. In some implementations, the second CU transport layer configuration includes a CU transport layer address (e.g., an IP address) to identify a first common DU-to-CU UL tunnel. The second CU transport layer configuration additionally includes a TEID for the CU-UP 172B. In further implementations, the CU-CP 172A includes the second CU transport layer configuration in the second CU-to-DU message and sends 516 the second CU-to-DU message to the DU 174 in response to the second DU-to-CU message of event 510. After receiving 566 the second UP-to-CP message or transmitting 516 the second CU-to-DU message, the CU-CP 172A sends 518 a second BS-to-CN message (e.g., Multicast Session Activation Response message) to the CN 110 in response to the first CN-to-BS message. Alternatively, the CU-CP 172A sends 518 the second BS-to-CN message to the CN 110 before receiving 566 the second UP-to-CP message or transmitting 516 the second CU-to-DU message. For example, the CU-CP 172A sends 518 the second BS-to-CN message to the CN 110 after receiving 504 the first CN-to-BS message, receiving 562 the first UP-to-CP message, receiving 510 the second DU-to-CU message or receiving 514 the second CN-to-BS message.

In some implementations, the CU-CP 172A includes the fourth MBS QoS flow configuration(s) in the MC Bearer Context Modification Request message. In some such implementations, the CU-UP 172B modifies or reconfigures resources for the MRB(s) based on the fourth MBS QoS flow configuration(s). In some implementations, the CU-UP 172B determines whether to modify or reconfigure resources for the MRB(s) based on the fourth MBS QoS flow configuration(s). For example, if the resources for the MRB(s) at event 562 still fulfill the fourth MBS QoS flow configuration(s), the CU-UP 172B does not modify or reconfigure resources for the first MRB. Otherwise, the CU-UP 172B modifies or reconfigures resources for the MRB(s) based on the fourth MBS QoS flow configuration(s). In some implementations, the CU-UP 172B determines whether to modify or reconfigure resources for a particular MRB of the MRB(s) based on the fourth MBS QoS flow configuration(s). For example, if the resources for a first MRB of the MRB(s) at event 562 still fulfill particular configuration(s) of the fourth MBS QoS flow configuration(s) for particular MBS QoS flow(s) mapped to the first MRB, the CU-UP 172B does not modify or reconfigure resources for the first MRB. Otherwise, the CU-UP 172B modifies or reconfigures resources for the first MRB based on the particular MBS QOS flow configuration(s).

The events 504, 560, 562, 506, 508, 510, 512, 514, 564, 566, 516, and 518 are collectively referred to in FIG. 5A as an MBS session resource setup procedure 592A.

In some implementations, the CN 110 sends 520 to the CU-CP 172A a third CN-to-BS message indicating that the UE 102 joins the first MBS session. In some implementations, the CN 110 includes, in the third CN-to-BS message, the first MBS session ID and/or MBS QoS flow identifier(s) identifying the first MBS session and MBS QoS flow(s) associated with the first MBS session, respectively. In response to the third CN-to-BS message, the CU-CP 172A sends 527 a third BS-to-CN message to the CN 110. In some implementations, after receiving the third CN-to-BS message, the CU-CP 172A sends 522 a UE Context Request message to the DU 174 for the UE 102. In some implementations, the CU-CP 172A includes the MRB ID(s) in the UE Context Request message. In further implementations, the CU-CP 172A determines the MRB ID(s) based on the first MBS session ID and/or MBS QoS flow identifier(s) received in the third CN-to-BS message. In some implementations, the CU-CP 172A does not include the first MBS session ID in the UE Context Request message.

In response to the UE Context Request message of event 522, the DU 174 sends 524, to the CU-CP 172A, a UE Context Response message including multicast configuration parameters for the UE 102A to receive MBS data of the first MBS session via the MRB(s). In some implementations, some or all of the multicast configuration parameters may be associated with the MRB(s) and/or MRB ID(s). In some implementations, the DU 174 generates a DU configuration (i.e., a first DU configuration) to include the multicast configuration parameters (i.e., first multicast configuration parameters) and includes the DU configuration in the UE Context Response message. In some implementations, the DU configuration is a CellGroupConfig IE. In other implementations, the DU configuration is an MBS-specific IE. In some implementations, the multicast configuration parameters configure one or more logical channels (LCs) for the MRB(s). For example, the multicast configuration parameters include one or more logical channel IDs (LCIDs) to configure the logical channel(s). Each of the LCIDs identifies a particular logical channel of the one or more logical channels. In some implementations, the third CN-to-BS message and the third BS-to-CN message are a PDU Session Resource Modify Request message and a PDU Session Resource Modify Response message, respectively. In other implementations, the third CN-to-BS message and the third BS-to-CN message arc a PDU Session Resource Setup Request message and a PDU Session Resource Setup Response message, respectively. In some implementations, the third CN-to-BS message and the third BS-to-CN message are UE-associated messages (e.g., the messages are associated with a particular UE 102).

In some implementations, the UE Context Request message and the UE Context Response message are a UE Context Setup Request message and a UE Context Setup Response message, respectively. In other implementations, the UE Context Request message and the UE Context Response message are a UE Context Modification Request message and a UE Context Modification Response message, respectively.

In some implementations, the CU-CP 172A performs a Bearer Context procedure (e.g., a UE-specific Bearer Context procedure) with the CU-UP 172B after receiving the third CN-to-BS message. In the Bearer Context procedure, the CU-CP 172A sends a Bearer Context Request message to the CU-UP 172B to request establishment or modification of a bearer context (e.g., a unicast bearer context) for the UE 102. In response, the CU-UP 172B establishes or modifies a bearer context for the UE 102 and sends a Bearer Context Response message to the CU-CP 172A. In other implementations, the CU-CP 172A refrains from performing a Bearer Context procedure for the UE 102 with the CU-UP 172B upon receiving the third CN-to-BS message. In some implementations, the Bearer Context procedure is a Bearer Context Setup procedure (e.g., as defined in section 8.3.1 in 3GPP specification 37.483 or 38.463). In some such cases, the Bearer Context Request message and Bearer Context Setup message are a Bearer Context Setup Request message and Bearer Context Setup Response message, respectively. In other implementations, the Bearer Context procedure is a Bearer Context Modification procedure (e.g., as defined in section 8.3.2 in 3GPP specification 37.483 or 38.463). In some such cases, the Bearer Context Request message and Bearer Context Setup message are a Bearer Context Modification Request message and Bearer Context Modification Response message, respectively.

After receiving 524 the UE Context Response message, the CU-CP 172A generates an RRC reconfiguration message (e.g., RRCReconfiguration message) including the multicast configuration parameters and one or more MRB configurations (e.g., first MRB configuration(s)) and transmits 526 the RRC reconfiguration message to the DU 174. The first MRB configuration(s) configure the MRB(s) (e.g., the MRB(s) 1, . . . , N). In some implementations, the first MRB configuration(s) include the MRB ID(s) and PDCP configuration(s). In turn, the DU 174 transmits 528 the RRC reconfiguration message to the UE 102 operating in the connected state. The UE 102 in the connected state then transmits 530 an RRC reconfiguration complete message to the DU 174, which in turn transmits 531 the RRC reconfiguration complete message (e.g., RRCReconfigurationComplete message) to the CU-CP 172A.

In some implementations, the UE 102 configures or establishes PDCP entity/entities (e.g., NR PDCP 210) for the MRB(s) and configures a MAC entity (e.g., MAC 204B) in accordance with the multicast configuration parameters.

The events 520, 522, 524, 526, 527 (discussed below), 528, 530, and 531 are collectively referred to in FIG. 5A as a UE-specific MBS session configuration procedure 594. The CN 110 and/or CU-CP 172A perform the procedure 594 for each of the UEs (e.g., the UE 102A and the UE 102B) joining the first MBS session. In some scenarios or implementations, the procedure 594 occurs before the procedure 592A. In other scenarios or implementations, the procedure 594 occurs after the procedure 592A. In yet other scenarios or implementations, the procedure 594 overlaps with the procedure 592A.

In some implementations, the CU-CP 172A generates a PDCP PDU including the RRC reconfiguration message and sends 526 a CU-to-DU message including the PDCP PDU to the DU 174. In such implementations, the DU 174 retrieves the PDCP PDU from the CU-to-DU message and transmits 528 the PDCP PDU to the UE 102 via the RLC layer 206B. MAC layer 204B, and PHY layer 202B. The UE 102 receives 528 the PDCP PDU from the DU 174 via the PHY layer 202B, MAC layer 204B, and RLC layer 206B. In some implementations, the UE 102 generates a PDCP PDU including the RRC reconfiguration complete message and transmits 530 the PDCP PDU to the DU 174 via the RLC layer 206B, MAC layer 204B, and PHY layer 202B. The DU 174 receives 530 the PDCP PDU from the UE 102 via the PHY layer 202B, MAC layer 204B, and RLC layer 206B, and sends 531 a DU-to-CU message including the PDCP PDU to the CU-CP 172A. The CU-CP 172A retrieves the PDCP PDU from the DU-to-CU message and retrieves the RRC reconfiguration complete message from the PDCP PDU.

In some implementations, before or after receiving 524 the UE Context Response message, the CU-CP 172A sends 527 the third BS-to-CN message to the CN 110 in response to the third CN-to-BS message 520. In some implementations, the CU-CP 172A sends 527 the third BS-to-CN message to the CN 110 before receiving 531 the RRC reconfiguration complete message. In other implementations, the CN 110 sends 527 the third BS-to-CN message to the CN 110 after receiving 531 the RRC reconfiguration complete message. Depending on the implementation, the CU-CP 172A includes a first CN UE interface ID and a first RAN UE interface ID in the third BS-to-CN message. In some implementations, the CN 110 assigns the first CN UE interface ID identifying the UE 102 (e.g., the UE 102A), and the CU-CP 172A assigns the first RAN UE interface ID identifying the UE 102 (e.g., the UE 102A). In some implementations, the “CN UE interface ID” is an “AMF UE NGAP ID” and the “RAN UE interface ID” is a “RAN UE NGAP ID”.

After receiving 518 the second BS-to-CN message or 527 the third BS-to-CN message, the CN 110 (e.g., (MB-)UPF 162) sends 532 MBS data (e.g., one or multiple MBS data packets) for the first MBS session to the CU-UP 172B via the first common CN-to-BS DL tunnel (e.g., in accordance with the first CU transport layer configuration and/or the first CN transport layer configuration). In some implementations, the CN 110 generates tunnel packets each including a particular MBS data packet to transmit the MBS data packets via the first common CN-to-BS DL tunnel. In a header of each of the tunnel packets, the CN 110 sets a source IP address, a target IP address and a TEID to the IP address in the first CN transport layer configuration, the IP address in the first CU transport layer configuration, and the TEID in the first CU transport layer configuration, respectively. In such implementations, the IP address in the first CN transport layer configuration, the IP address in the first CU transport layer configuration, and the TEID in the first CU transport layer configuration identify the first common CN-to-BS DL tunnel.

When the CU-UP 172B receives 532 the MBS data of the first MBS session from the CN 110, the CU-UP 172B in turn sends 534 the MBS data to the DU 174 via the first common CU-to-DU tunnel and/or additional common CU-to-DU DL tunnel (i.e., in accordance with the first and/or additional DU transport layer configuration(s)). In some cases where the MBS data is associated with some of the MBS QoS flow(s) identified by the MBS QOS flow identifier(s), the CU-UP 172B determines which common CU-to-DU DL tunnel(s) to use to send the MBS data to the DU 174 based on the MBS QOS flow identifier(s). For example, when the CU-UP 172B receives, from the CN 110, a first MBS data packet associated with a first one of the MBS QoS flow identifier(s), the CU-UP 172B sends the first MBS data packet to the DU 174 via the first common CU-to-DU DL tunnel. When the CU-UP 172B receives from the CN 110 a second MBS data packet associated with a second one of the MBS QOS flow identifier(s), the CU-UP 172B sends the second MBS data packet to the DU 174 via one of the additional common CU-to-DU tunnel(s). In some implementations, the CU-UP 172B generates tunnel packets each including a particular MBS data packet to transmit the MBS data packets via the first common CU-to-DU tunnel and/or additional common CU-to-DU DL tunnel. In cases where the CU-UP 172B transmits one of the tunnel packets via the first common CU-to-DU tunnel, the CU-UP 172B sets a source IP address, a target IP address, and a TEID in a header of the tunnel packet to the IP address in the second CU transport layer configuration, the IP address in the first DU transport layer configuration, and the TEID in the first DU transport layer configuration, respectively. In such implementations, the IP address in the second CU transport layer configuration, the IP address in the first DU transport layer configuration, and the TEID in the first DU transport layer configuration identify the first common CU-to-DU DL tunnel. In cases where the CU-UP 172B transmits one of the tunnel packets via the additional common CU-to-DU tunnel, the CU-UP 172B sets a source IP address, a target IP address, and a TEID in a header of the tunnel packet to the IP address in the second CU transport layer configuration, the IP address in the additional DU transport layer configuration, and the TEID in the additional DU transport layer configuration, respectively. In such implementations, the IP address in the second CU transport layer configuration, the IP address in the additional DU transport layer configuration, and the TEID in the additional DU transport layer configuration identify the first common CU-to-DU DL tunnel.

When the DU 174 receives 534 the MBS data from the CU-UP 172B, the DU 174 transmits (e.g., multicast or unicast) 536 the MBS data via the one or more logical channels to the UE 102. The UE 102 receives 536 the MBS data via the one or more logical channels. For example, the CU-UP 172B receives 532 an MBS data packet, generates a PDCP PDU including the MBS data packet, and transmits 534 the PDCP PDU to the DU 174. In turn, the DU 174 generates a MAC PDU including the logical channel ID and the PDCP PDU, and transmits 536 the MAC PDU to the UE 102 via multicast or unicast. The UE 102 receives 536 the MAC PDU via multicast or unicast, retrieves the PDCP PDU and the logical channel ID from the MAC PDU, identifies the PDCP PDU associated with the MRB in accordance with the logical channel ID, and retrieves the MBS data packet from the PDCP PDU in accordance with a PDCP configuration within the MRB configuration. In some implementations, the DU 174 transmits 536 the MBS data or the MAC PDU via one or more multicast transmissions (e.g., dynamic or SPS multicast transmission(s)) to the UE 102 as described above. In some such cases, the UE 102 receives 536 the MBS data or the MAC PDU via the one or more multicast transmissions from the DU 174 as described above. In some implementations, the UE 102 uses the MAC entity to receive 536 the MAC PDU or MBS data and uses the PDCP entity/entities to process the PDCP PDU to obtain the MBS data.

In some implementations, the CU-CP 172A requests the DU 174 to configure a UE-specific CU-to-DU DL tunnel for the UE 102 in the UE Context Request message of event 522. In some implementations, the CU-CP 172A includes a CU transport layer configuration in the UE Context Request message to request a UE-specific CU-to-DU DL tunnel for the UE 102. The CU transport layer configuration includes a CU transport layer address (e.g., an IP address) to identify a UE-specific CU-to-DU DL tunnel. In some implementations, the CU transport layer configuration additionally includes a TEID for the CU-UP 172B. In response, the DU 174 includes, in the UE Context Response message, a DU transport layer configuration configuring the UE-specific CU-to-DU DL tunnel. The DU transport layer configuration includes a DU transport layer address (e.g., an IP address and/or a TEID). In some implementations, after receiving 524 the UE Context Response message, the CU-CP 172A sends a Bearer Context Modification Request message, including the DU transport layer configuration, to the CU-UP 172B and, in response, the CU-UP 172B sends a Bearer Context Modification Response message to the CU-CP 172A. In further implementations, the CU-UP 172B then transmits 534 the MBS data to the DU 174 via the UE-specific CU-to-DU DL tunnel.

In some implementations, the multicast configuration parameters also includes one or more RLC bearer configurations, each associated with a particular MRB. Each of the MRB configuration(s) includes an MRB ID, a PDCP configuration, the first MBS session ID, a PDCP reestablishment indication (e.g., reestablishPDCP), and/or a PDCP recovery indication (e.g., recoveryPDCP). In some implementations, the PDCP configuration is a PDCP-Config IE for DRB. In further implementations, the RLC bearer configuration is an RLC-BearerConfig IE. In some implementations, the RLC bearer configuration includes a logical channel (LC) ID configuring a logical channel. In some implementations, the logical channel is an MBS traffic channel (MTCH). In other implementations, the logical channel is a dedicated traffic channel (DTCH). In some implementations, the multicast configuration parameters include a logical channel configuration (e.g., LogicalChannelConfig IE) configuring the logical channel. In some implementations, the RLC bearer configuration include the MRB ID.

In some implementations, the CU-CP 172A configures the MRB as a DL-only RB in the MRB configuration. For example, the CU-CP 172A refrains from including UL configuration parameters in the PDCP configuration within the MRB configuration to configure the MRB as a DL-only RB. The CU-CP 172A includes only DL configuration parameters in the MRB configuration (e.g., as described above). In such cases, the CU-CP 172A configures the UE 102 to not transmit UL PDCP data PDU via the MRB to the DU 174 and/or the CU-CP 172A by excluding the UL configuration parameters for the MRB in the PDCP configuration in the MRB configuration. In another example, the DU 174 refrains from including UL configuration parameters in the RLC bearer configuration. In such cases, the DU 174 configures the UE 102 not to transmit the control PDU(s) via the logical channel to the base station 104 by excluding the UL configuration parameters from the RLC bearer configuration.

In cases where the DU 174 includes UL configuration parameter(s) in the RLC bearer configuration, the UE 102 transmits control PDU(s) (e.g., PDCP Control PDU(s) and/or RLC Control PDU(s)) via the logical channel to the DU 174 using the UL configuration parameter(s). In some implementations, if the control PDU is a PDCP control PDU, the DU 174 sends the PDCP control PDU to the CU-UP 172B. For example, the CU-CP 172A configures the CE 102 to receive MBS data with a compression or decompression protocol (e.g., robust header compression (ROHC) protocol). In such cases, when the CU-UP 172B receives 532 an MBS data packet from the CN 110, the CU-UP 172B compresses the MBS data packet with the compression protocol to obtain compressed MBS data packet(s) and transmits 534 a PDCP PDU, including the compressed MBS data packet, to the DU 174 via the first or additional common CU-to-DU DL tunnel. In turn, the DU 174 transmits (e.g., multicast or unicast) 536 the PDCP PDU to the UE 102 via the logical channel. When the UE 102 receives the PDCP PDU via the logical channel, the UE 102 retrieves the compressed MBS data packet from the PDCP PDU. The UE 102 decompresses the compressed MBS data packet(s) with the compression or decompression protocol to obtain the original MBS data packet. In some such cases, the UE 102 transmits a PDCP Control PDU, including a header compression protocol feedback (e.g., interspersed ROHC feedback) for operation of the header compression or decompression protocol, via the logical channel to the DU 174. In turn, the DU 174 sends the PDCP Control PDU to the CU-UP 172B via a UL tunnel. In some implementations, the UL tunnel is a first common DU-to-CU tunnel configured in the first DU transport layer configuration and the second CU transport layer configuration. For example, the IP address in the first DU transport layer configuration and the IP address and TEID in the second CU transport layer configuration identify the first common DU-to-CU tunnel. In other implementations, the UL tunnel is specific for the UE 102. In some implementations, the CU-CP 172A includes, in the UE Context Request message, a CU transport layer configuration configuring the UE-specific UL tunnel. The CU transport layer configuration includes a CU transport layer address (e.g., an Internet Protocol (IP) address) and a TEID to identify the UE-specific UL tunnel. The DU 174 includes, in the UE Context Response message, a DU transport layer configuration configuring the UE-specific UL tunnel. The DU transport layer configuration includes a DU transport layer address (e.g., an IP address and/or a TEID). For example, the IP address in the DU transport layer configuration and the IP address and TEID in the CU transport layer configuration identify the first common UL tunnel.

In some implementations, the MRB configuration is an MRB-ToAddMod IE including an MRB ID (e.g., mrb-Identity or MRB-Identity). An MRB ID identifies a particular MRB of the MRB(s). In some cases where the CU-CP 172A has configured DRB(s) to the UE 102 for unicast data communication, the CU-CP 172A sets one or more of the MRB ID(s) to values different from DRB ID(s) of the DRB(s). In some such cases, the UE 102 and the CU-CP 172A distinguish whether an RB is an MRB or DRB in accordance with an RB ID of the RB. In other implementations, the CU-CP sets one or more of the MRB ID(s) to values which are the same as the DRB ID(s). In some such cases, the UE 102 and the CU-CP 172A distinguish whether an RB is an MRB or DRB in accordance with an RB ID of the RB and an RRC IE configuring the RB. For example, a DRB configuration configuring a DRB is a DRB-ToAddMod IE including a DRB identity (e.g., drb-Identity or DRB-Identity) and a PDCP configuration. Thus, in some such implementations, the UE 102 determines an RB is a DRB if the UE 102 receives a DRB-ToAddMod IE configuring the RB, and the UE 102 determines an RB is an MRB if the UE 102 receives an MRB-ToAddMod IE configuring the RB. Similarly, the CU-CP 172A determines an RB is a DRB if the CU-CP 172A transmits a DRB-ToAddMod IE configuring the RB to the UE 102, and determines an RB is an MRB if the CU-CP 172A transmits an MRB-ToAddMod IE configuring the RB to the UE 102.

In some implementations, the multicast configuration parameters for receiving MBS data of the first MBS session include one or more logical channel (LC) IDs to configure one or more logical channels. In some implementations, the logical channel(s) are dedicated traffic channel(s) (DTCH(s)). In other implementations, the logical channel(s) are multicast traffic channel(s) (MTCH(s)).

In some implementations, the multicast configuration parameters include dynamic scheduling multicast configuration parameter(s) for the UE 102 to receive multicast transmissions, each including MBS data or a particular portion of MBS data. In some implementations, the dynamic scheduling multicast configuration parameter(s) include at least one of the following configuration parameters. A first example parameter is a group radio network temporary identifier (G-RNTI), for which the DU 174 dynamically schedules each multicast transmission, including a particular MAC PDU, for the UE 102 by generating a DCI, scrambling a cyclic redundancy check (CRC) of the DCI with the G-RNTI, and transmitting the DCI and the scrambled CRC on a PDCCH. In some implementations, the MAC PDU includes an MBS data packet or a portion of an MBS data packet. The UE 102 receives the DCI and scrambled CRC on the PDCCH and verifies the scrambled CRC with the G-RNTI. For each multicast transmission, after the UE 102 verifies that the CRC is valid, the UE 102 receives the multicast transmission in accordance with the corresponding DCI and retrieves the particular MAC PDU from the multicast transmission. In such cases, each multicast transmission is a dynamic scheduling multicast transmission used in the following description. In some implementations, each DCI includes configuration parameters configuring a dynamic scheduling multicast radio resource scheduling the corresponding multicast transmission. In some implementations, the configuration parameters include at least one of the following parameters. The configuration parameters of each DCI include the same values and/or different values for the following configuration parameters: (i) Frequency domain resource assignment; (ii) Time domain resource assignment; (iii) Virtual resource block (VRB)-to-physical resource block (PRB) mapping; (iv) Modulation and coding scheme (MCS); (v) New data indicator; (vi) Redundancy version; (vii) HARQ process number; (viii) Downlink assignment index; and/or (ix) PUCCH resource indicator. Another example parameter is a HARQ codebook (ID), which indicates a HARQ acknowledgement (ACK) codebook index for a corresponding HARQ ACK codebook for a dynamic scheduling multicast transmission received by the UE 102. The DU 174 uses the HARQ codebook (ID) to receive a HARQ ACK. In some cases where the configuration parameters do not include the HARQ codebook (ID), the UE 102 and DU 174 use a HARQ codebook (ID) for unicast transmission. In some implementations, the UE 102 receives the HARQ codebook (ID) for unicast transmission in the DU configuration from the DU 174. In other implementations, the UE 102 receives the HARQ codebook (ID) for unicast transmission in another DU configuration from the DU 174, similar to events 516, 518, and 520. Another example parameter is a PUCCH resource configuration, which indicates a HARQ resource on a PUCCH where the UE 102 transmits a HARQ feedback (e.g., HARQ ACK and/or negative ACK (NACK)) for a dynamic scheduling multicast transmission. In some cases where the configuration parameters do not include the PUCCH resource configuration, the UE 102 and DU 174 use a PUCCH resource configuration for unicast transmissions to communicate HARQ feedback. Another example parameter is a HARQ NACK-only indication, which configures the UE 102 to only transmit a HARQ negative ACK (NACK) for a dynamic scheduling multicast transmission that the UE 102 receives from the DU 174, and from which the UE 102 fails to obtain a transport block. In some implementations, the UE 102 fails to obtain the transport block because the UE 102 fails a cyclic redundancy check (CRC) for the transport block, or the UE 102 does not receive the dynamic scheduling multicast transmission. In accordance with the indication, the UE 102 refrains from transmitting to the DU 174 a HARQ ACK for a dynamic scheduling multicast transmission that the UE 102 successfully receives and from which the UE 102 obtains a transport block. In some cases where the configuration parameters do not include the indication, the UE 102 transmits, to the DU 174, a HARQ ACK for a dynamic scheduling multicast transmission that the UE 102 successfully receives, and from which the UE 102 obtains a transport block. Another example parameter is a HARQ ACK/NACK indication, which configures the UE 102 to transmit a HARQ NACK for a dynamic scheduling multicast transmission where the UE 102 fails to obtain a transport block and configures the UE 102 to transmit a HARQ ACK for a dynamic scheduling multicast transmission that the UE 102 successfully receives, and from which the UE 102 obtains a transport block. In cases where the configuration parameters do not include the indication, the UE 102 refrains from transmitting to the DU 174 a HARQ ACK for a dynamic scheduling multicast transmission that the UE 102 successfully receives, and from which the UE 102 obtains a transport block. In some such cases, the UE 102 is only to transmit, to the DU 174, a HARQ NACK for a dynamic scheduling multicast transmission where the UE 102 fails to obtain a transport block. Another example parameter is a HARQ ACK indication, which configures the UE 102 to transmit a HARQ ACK for a dynamic scheduling multicast transmission that the UE 102 successfully receives, and from which the UE 102 obtains a transport block. In cases where the configuration parameters do not include the indication, the UE 102 refrains from transmitting, to the DU 174, a HARQ ACK for a dynamic scheduling multicast transmission where the UE 102 successfully obtains a transport block. In such cases, the UE 102 is only to transmit, to the DU 174, a HARQ NACK for a dynamic scheduling multicast transmission where the UE 102 fails to obtain a transport block. In some implementations, the DU 174 includes any one of the HARQ NACK indication, HARQ ACK/NACK indication, and/or HARQ ACK indication. Another example parameter is a modulation and coding scheme (MCS) configuration, which indicates an MCS table that the DU 174 uses to transmit dynamic scheduling multicast transmissions, and the UE 102 uses to receive dynamic scheduling multicast transmissions. For example, the MCS table is a particular MCS table (e.g., as defined in 3GPP specification 38.214 (e.g., a low-SE 64QAM table indicated in Table 5.1.3.1-3 of 3GPP TS 38.214 or a new table specific for multicast transmission)). In some implementations, if DU 174 does not include the MCS configuration in the DU configuration, the UE 102 and DU 174 apply a predefined MCS table (e.g., as defined in 3GPP specification 38.214). For example, the predefined MCS table is a 256QAM table or a 64QAM table (e.g., as indicated in Table 5.1.3.1-2 or non-low-SE 64QAM table indicated in Table 5.1.3.1-1 of the specification 38.214, respectively). In cases where the DU 174 does not include the MCS configuration in the DU configuration, the UE 102 and DU 174 apply an MCS table for unicast transmission to receive dynamic scheduling multicast transmissions from the DU 174. In some implementations, the DU 174 includes, in the DU configuration, a PDSCH configuration (e.g., PDSCH-Config IE) configuring the MCS table for unicast transmissions. In other implementations, the DU 174 transmits, to the UE 102, another DU configuration including the PDSCH configuration, similar to events 516, 518, and 520. Another example parameter is an aggregation factor, which is the number of repetitions for dynamic scheduling multicast transmission(s). In some implementations, the DU 174 transmits (e.g., multicast) a number of repetitions of a dynamic scheduling multicast transmission in accordance with the aggregation factor, and the UE 102 receives the repetitions based on the aggregation factor. In some cases where the DU 174 does not include the aggregation factor in the DU configuration, the UE 102 in some implementations applies an aggregation factor for unicast transmission(s). In some implementations, the DU 174 includes the aggregation factor for unicast transmission(s) to the UE 102 in the DU configuration. In other implementations, the DU 174 transmits another DU configuration, including the aggregation factor for unicast transmissions, to the UE 102, similar to events 516, 518, and 520.

The RRC reconfiguration messages for UEs joining the first MBS session include the same multicast configuration parameters for receiving MBS data of the first MBS session. In some implementations, the RRC reconfiguration messages for the UEs include the same or different configuration parameters for receiving non-MBS data.

In some implementations, the multicast configuration parameters include at least one semi-persistent scheduling (SPS) multicast configuration for the UE 102 to receive MBS data. Depending on the implementation, each of the SPS multicast configuration(s) include at least one of the following parameters for SPS multicast transmissions. An example first parameter is a group configured scheduling radio network temporary identifier (G-CS-RNTI), which is used to activate or release an SPS multicast radio resource. In some implementations, the DU 174 activates an SPS multicast radio resource for the UE 102 by generating an SPS multicast radio resource activation command (e.g., a DCI), scrambling a CRC of the DCI with the G-CS-RNTI, and transmitting the DCI and the scrambled CRC on a PDCCH. After activating the SPS multicast radio resource, the DU 174 periodically transmits a multicast transmission on the SPS multicast radio resource in accordance with the DCI. The UE 102 receives the DCI and scrambled CRC on the PDCCH and verifies the scrambled CRC with the G-CS-RNTI. After the UE 102 verifies that the CRC is valid, the UE 102 activates (e.g., begins to receive on) the SPS multicast radio resource in response to the DCI, and periodically receives a multicast transmission on the SPS multicast radio resource in accordance with the SPS multicast radio resource activation command (e.g., DCI) before the UE 102 deactivates the SPS multicast radio resource. In such cases, the multicast transmission is an SPS multicast transmission used in the following description. In some implementations, the DU 174 deactivates or releases the SPS multicast radio resource by generating an SPS multicast radio resource deactivation command (e.g., a DCI), scrambling a CRC of the DCI with the G-CS-RNTI, and transmitting the DCI and the scrambled CRC on a PDCCH. The UE 102 receives the DCI and scrambled CRC on the PDCCH and verifies the scrambled CRC with the G-CS-RNTI. After the UE 102 verifies that the CRC is valid, the UE 102 deactivates the SPS multicast radio resource (e.g., stops receiving on the SPS multicast radio resource). Depending on the implementation, each of the SPS multicast transmissions includes a particular MAC PDU, which includes an MBS data packet or a portion of an MBS data packet. In some implementations, the SPS multicast radio resource activation command (e.g., DCI) includes configuration parameters configuring the SPS multicast radio resource. In some implementations, the configuration parameters include at least one of the following parameters: (i) Frequency domain resource assignment; (ii) Time domain resource assignment; (iii) Virtual resource block (VRB)-to-physical resource block (PRB) mapping; (iv) Modulation and coding scheme (MCS); (v) New data indicator; (vi) Redundancy version; (vii) HARQ process number; (viii) Downlink assignment index; and/or (ix) PUCCH resource indicator. Another example parameter is a periodicity, which indicates a periodicity of the SPS multicast radio resource.

Another example parameter is a number of HARQ processes, which indicates a number of HARQ processes for communicating SPS multicast transmissions. The DU 174 uses, at most, the number of HARQ processes to transmit SPS multicast transmissions, and the UE 102 uses, at most, the number of HARQ processes to receive the SPS multicast transmissions. Another example parameter is a HARQ codebook ID, which indicates a HARQ ACK codebook index for a corresponding HARQ ACK codebook for an SPS multicast transmission or an SPS multicast radio resource deactivation command received by the UE 102. In some cases where the configuration parameters do not include the HARQ codebook (ID), the UE 102 uses a HARQ codebook (ID) for dynamic scheduling multicast transmission as described above. Alternatively, the UE 102 uses a HARQ codebook (ID) for unicast transmission. In some implementations, the UE 102 receives the HARQ codebook (ID) for unicast transmission in the DU configuration from the DU 174 as described above. Another example parameter is a HARQ process ID offset, which indicates an offset used in deriving HARQ process IDs for the DU 174 to transmit SPS multicast transmissions and for the UE 102 to receive SPS multicast transmissions. Another example parameter is a PUCCH resource configuration for SPS multicast transmission, which indicates a HARQ resource on a PUCCH where the UE 102 transmits HARQ feedback (e.g., HARQ ACK and/or negative ACK (NACK)) for an SPS multicast transmission. In some cases where the configuration parameters do not include the PUCCH resource configuration for SPS multicast transmission, the UE 102 and DU 174 use a PUCCH resource configuration for dynamic scheduling multicast transmission to communicate a HARQ feedback as described above. Alternatively, the UE 102 uses a PUCCH resource configuration for unicast transmissions. In some implementations, the UE 102 uses the PUCCH resource configuration for unicast transmissions as described above. Another example parameter is a HARQ NACK only indication, which configures the UE 102 to only transmit a HARQ negative ACK (NACK) for an SPS multicast transmission that the UE 102 receives from the DU 174, and from which the UE 102 fails to obtain a transport block. In some implementations, the UE 102 fails to obtain the transport block because the UE 102 fails a cyclic redundancy check (CRC) for the transport block, or the UE 102 does not receive the dynamic scheduling multicast transmission. In accordance with the indication, the UE 102 refrains from transmitting, to the DU 174, a HARQ ACK for an SPS multicast transmission that the UE 102 successfully receives, and from which the UE 102 obtains a transport block. In some cases where the configuration parameters do not include the indication, the UE 102 transmits, to the DU 174, a HARQ ACK for an SPS multicast transmission that the UE 102 successfully receives, and from which the UE 102 obtains a transport block. Another example parameter is a HARQ ACK/NACK indication, which configures the UE 102 to transmit a HARQ NACK for an SPS multicast transmission where the UE 102 fails to obtain a transport block and configures the UE 102 to transmit a HARQ ACK for an SPS multicast transmission that the UE 102 successfully receives, and from which the UE 102 obtains a transport block. In cases where the configuration parameters do not include the indication, the UE 102 refrains from transmitting to the DU 174 a HARQ ACK for an SPS multicast transmission that the UE 102 successfully receives and obtains a transport block. In such cases, the UE 102 is only to transmit, to the DU 174, a HARQ NACK for an SPS multicast transmission where the UE 102 fails to obtain a transport block. Another example parameter is a HARQ ACK indication, which configures the UE 102 to transmit a HARQ ACK for an SPS multicast transmission that the UE 102 successfully receives, and from which the UE 102 obtains a transport block. In cases where the configuration parameters do not include the indication, the UE 102 refrains from transmitting to the DU 174 a HARQ ACK for an SPS multicast transmission where the UE 102 successfully obtains a transport block. In such cases, the UE 102 is only to transmit, to the DU 174, a HARQ NACK for an SPS multicast transmission where the UE 102 fails to obtain a transport block. In some implementations, the DU 174 includes any one of the HARQ NACK indication, HARQ ACK/NACK indication, and/or HARQ ACK indication. Another example parameter is an aggregation factor, which is the number of repetitions for SPS multicast transmission(s). The DU 174 transmits a number of repetitions of an SPS multicast transmission in accordance with the aggregation factor, and the UE 102 receives the repetitions based on the aggregation factor. In some cases where the DU 174 does not include the aggregation factor in the DU configuration, the UE 102 and DU 174 apply an aggregation factor for dynamic scheduling multicast transmission as described above. Alternatively, the UE 102 and DU 174 apply an aggregation factor for unicast transmission(s). In some implementations, the UE 102 and DU 174 apply an aggregation factor for unicast transmission(s) as described above. Another example parameter is an MCS configuration, which indicates an MCS table that the DU 174 uses to transmit an SPS multicast transmission, and the UE 102 uses to receive the SPS multicast transmission. For example, the MCS table is a particular MCS table (e.g., as defined in 3GPP specification 38.214 (e.g., a low-SE 64QAM table indicated in Table 5.1.3.1-3 of 3GPP TS 38.214 or a new table specific for multicast transmission)). In some implementations, if DU 174 does not include the MCS configuration in the DU configuration, the UE 102 and DU 174 apply a predefined MCS table (e.g., as defined in 3GPP specification 38.214). For example, the predefined MCS table is a 256QAM table or a 64QAM table (e.g., as indicated in Table 5.1.3.1-2 or non-low-SE 64QAM table indicated in Table 5.1.3.1-1 of the specification 38.214, respectively). In some cases where the DU 174 does not include the MCS configuration in the DU configuration, the UE 102 and DU 174 in other implementations apply an MCS table for dynamic scheduling multicast transmission to receive SPS multicast transmissions from the DU 174, as described above. Alternatively, the UE 102 and DU 174 apply an MCS table for unicast transmission to receive SPS multicast transmissions from the DU 174. In some implementations the UE 102 and DU 174 apply an MCS table for unicast transmission to receive SPS multicast transmissions from the DU 174, as described above. In some implementations, the DU 174 include, in the DU configuration, a PDSCH configuration (e.g., PDSCH-Config IE) configuring the MCS table for unicast transmissions. In other implementations, the DU 174 transmits, to the UE 102, another DU configuration including the PDSCH configuration, similar to events 516, 518, and 520.

In some implementations, the CU-CP 172A includes the MBS session join response message in the RRC reconfiguration message. In further implementations, the UE 102 includes the MBS session join complete message in the RRC reconfiguration complete message. Alternatively, the UE 102 sends a UL RRC message including the MBS session join complete message to the CU-CP 172A via the DU 174. Depending on the implementation, the UL RRC message is an ULInformationTransfer message or any suitable RRC message that can include a UL NAS PDU. In some implementations, the CU-CP 172A includes the MBS session join complete message in the second BS-to-CN message. Alternatively, the CU-CP 172A sends, to the CN 110, a BS-to-CN message (e.g., an UPLINK NAS TRANSPORT message) including the MBS session join complete message.

In other implementations, the CU-CP 172A transmits a DL RRC message that includes the MBS session join response message to the UE 102. Depending on the implementation, the DL RRC message is a DLInformationTransfer message, another RRC reconfiguration message, or any suitable RRC message that can include a DL NAS PDU. In some implementations, the UE 102 sends a UL RRC message including the MBS session join complete message to the CU-CP 172A via the DU 174. In further implementations, the UL RRC message is an ULInformationTransfer message, another RRC reconfiguration complete message, or any suitable RRC message that can include a UL NAS PDU.

The events 532, 534, and 536 are collectively referred to in FIG. 5A as an MBS session data transmission procedure 596.

In some cases where the CU-CP 172A does not receive slice information from the CN 110, the CU-CP 172A includes preconfigured slice information in the first CP-to-UP message of event 560. In some cases where the CU-CP 172A does not receive slice information from the CN 110, the CU-CP 172A includes preconfigured slice information in the first CU-to-DU message of event 506.

FIG. 5B illustrates an example scenario 500B similar to the scenarios 500A illustrated in FIG. 5A. In the scenario 500B, the CN 110 includes the first MBS QoS flow configuration(s) in the second CN-to-BS message of event 514. In some such cases, the CN 110 does not include the first MBS QoS flow configuration(s) in the first CN-to-BS message. After receiving the second CN-to-BS message, the CU-CP 172A sends 560 the first CP-to-UP message and 506 the first CU-to-DU message to the CU-UP 172B and DU 174, respectively. In other words, the CU-CP 172A delays sending the first CP-to-UP message and first CU-to-DU message (e.g., delays performing the MC Bearer Context Setup procedure and the Multicast Context Setup procedure) until receiving the first MBS QoS flow configuration(s) or the second CN-to-BS message.

The events 502, 512, 514, 560, 562, 506, 508, 510, 564, 566, 516, and 518 are collectively referred to in FIG. 5B as an MBS session resource setup procedure 592B.

In some implementations, the CN 110 includes the first slice information in the second CN-to-BS message of event 514. In some such cases, the CN 110 does not include the first slice information in the first CN-to-BS message. In some implementations, the CN 110 includes the first MBS area information in the second CN-to-BS message of event 514. In some such cases, the CN 110 does not include the first MBS area information in the first CN-to-BS message.

FIG. 5C illustrates an example scenario 500C similar to the scenarios 500A and 500B illustrated in FIGS. 5A and 5B, respectively. In the scenario 500C, the CN 110 includes the first MBS QoS flow configuration(s) in the third CN-to-BS message of event 520. After receiving the third CN-to-BS message, the CN 110. CU-CP 172A. CU-UP 172B, and DU 174 perform 592A or 592B the MBS session resource configuration procedure, except that the CU-CP 172A generates the second MBS QoS flow configuration(s) based on the first MBS QOS flow configuration(s) received in the third CN-to-BS message of event 520. In some implementations, events 504 and 518 in the procedure 592A or 592B can be omitted for scenario 500C. In some implementations, the CU-CP 172A transmits 527 the third BS-to-CN message to the CN 110 before, during, or after the procedure 592A or 592B.

The events 520, 527, and 592A or 592B are collectively referred to in FIG. 5C as an MBS session resource setup procedure 592C.

In some implementations, the CN 110 includes the first slice information in the third CN-to-BS message of event 520. In some such cases, the CN 110 does not include the first slice information in the first CN-to-BS message. In some implementations, the CN 110 includes the first MBS area information in the third CN-to-BS message of event 520. In some such cases, the CN 110 does not include the first MBS area information in the first CN-to-BS message.

FIG. 5D illustrates an example scenario 500D in which the CN 110 and base station 104 manage the transmission of downlink data for an MBS session to a UE operating in a connected state and in an inactive state. In some implementations of the scenario 500D, while the UE 102 communicates 596 with the base station 104, the CU-CP 172A determines 542 to cause the UE 102 to transition to an inactive state from the connected state based on data inactivity of the UE 102 (i.e., the UE 102 in the connected state has no data activity with the base station 104 except receiving MBS data). In some implementations, such as while the UE 102 communicates with the base station 104, the UE 102 determines or detects data inactivity and transmits 535, to the DU 174, UE assistance information (e.g., a UEAssistanceInformation message) indicating that the UE 102 prefers or requests to transition to the inactive state or leave the connected state. In turn, the DU 174 transmits 537 a UL RRC Message Transfer message, including the UE assistance information, to the CU-CP 172A. Thus, in some such implementations, the CU-CP 172A determines that the UE 102 has data inactivity based on the UE assistance information.

In other implementations, the DU 174 performs data inactivity monitoring for the UE 102. In some such implementations, the CU-CP 172A transmits a CU-to-DU message (e.g., a UE Context Setup Request message or a UE Context Modification Request message) to the DU 174 to request or command the DU 174 to perform the data inactivity monitoring. In some cases where the DU 174 detects or determines that the UE 102 has data inactivity during the monitoring, the DU 174 transmits 538 an inactivity notification (e.g., UE Inactivity Notification message) to the CU-CP 172A. Thus, the CU-CP 172A determines that the UE 102 has data inactivity based on the inactivity notification received from the DU 174.

In yet other implementations, the CU-UP 172B performs data inactivity monitoring for the UE 102. In some such implementations, the CU-CP 172A transmits a CP-to-UP message (e.g., a Bearer Context Setup Request message or a Bearer Context Modification Request message) to the CU-UP 172B to request or command the CU-UP 172B to perform the data inactivity monitoring. In some cases where the CU-UP 172B detects or determines that the UE 102 has data inactivity during the monitoring, the CU-UP 172B transmits 540 an inactivity notification (e.g., Bearer Context Inactivity Notification message) to the CU-CP 172A. Thus, the CU-CP 172A determines that the UE 102 has data inactivity based on the inactivity notification received from the CU-UP 172B. In some implementations, the CU-CP 172A determines that the UE 102 has data inactivity based on the UE assistance information, inactivity notification of the event 538, and/or inactivity notification of the event 540.

In some implementations, after a certain period of data inactivity, the CU-CP 172A determines that neither the CU 172 (i.e., the CU-CP 172A and/or the CU-UP 172B) nor the UE 102 has transmitted any unicast data in the downlink direction or the uplink direction, respectively, during the certain period. In some implementations, in response to the determination, the CU-CP 172A determines 542 to cause the UE 102 to transition to the inactive state.

In response to or after determining that the UE 102 has data inactivity (e.g., for a certain period) or determining to cause the UE 102 to transition to the inactive state, the CU-CP 172A sends 544 to the CU-UP 172B a Bearer Context Modification Request message to suspend unicast data transmission for the UE 102. In response, the CU-UP 172B suspends data transmission for the UE 102 and sends 546 a Bearer Context Modification Response message to the CU-CP 172A. In some implementations, in response to or after determining that the UE 102 has data inactivity or determining to cause the UE 102 to transition to the inactive state, the CU-CP 172A sends 548 a CU-to-DU message (e.g., a UE Context Modification Request message) to instruct the DU 174 to provide multicast configuration parameter(s) for the inactive state. In some implementations, the CU-CP 172A includes a multicast request indication (e.g., multicast indication for the inactive state) to request multicast configuration parameter(s) for the inactive state in the CU-to-DU message of event 548.

In further implementations, in response to the multicast request indication or the CU-to-DU message, the DU 174 transmits 550, to the CU-CP 172A, a DU-to-CU message (e.g., UE Context Modification Response message) including multicast configuration parameter(s) for the inactive state (i.e., second multicast configuration parameter(s) for the UE 102 operating in the inactive state to receive from the DU 174 multicast transmissions including MBS data). Alternatively, the DU 174 does not include the second multicast configuration parameter(s) in the DU-to-CU message of event 548. Instead, the DU 174 sends, to the CU-CP 172A, an additional DU-to-CU message (e.g., UE Context Modification Required message), including the second multicast configuration parameter(s), after receiving the CU-to-DU message of event 548 or transmitting the DU-to-CU message of event 550. In some implementations, the CU-CP 172A transmits an additional CU-to-DU message (e.g., UE Context Modification Confirm message) to the DU 174 in response to the additional CU-to-DU message.

Depending on the implementation, in response to determining to cause the UE 102 to transition to the inactive state, the CU-CP 172A generates an RRC release message (e.g., RRCRelease message or RRCConnectionRelease message) to cause the UE 102 to transition to the inactive state. In some implementations, the CU-CP 172A includes the second multicast configuration parameter(s) for the inactive state (e.g., if obtained from the DU 174) and/or an MRB configuration for the inactive state (e.g., a second MRB configuration) in the RRC release message. The CU-CP 172A then sends 552, to the DU 174, a CU-to-DU message (e.g., a UE Context Release Command message, a UE Context Modification Request message, or a DL RRC Message Transfer message) which includes the RRC release message. In turn, the DU 174 transmits 554 the RRC release message or the PDCP PDU to the UE 102. In some implementations, the DU 174 generates a MAC PDU including the RRC release message, and transmits 554 the MAC PDU to the UE 102. The RRC release message instructs the UE 102 to transition to the inactive state. The UE 102 transitions 556 to the inactive state from the connected state upon receiving the RRC release message. In some implementations, the UE 102 stops or suspends receiving unicast data from the DU 174 in response to the RRC release message or transitioning 556 to the inactive state. For example, the unicast data includes data associated with SRB(s) and/or DRB(s). In some implementations, the UE 102 stops using UE-specific radio network temporary identifier(s) (RNTI(s)) (e.g., the RNTI(s) are specific for the UE 102) to monitor a PDCCH in response to the RRC release message or transitioning 556 to the inactive state. In some implementations, the UE specific RNTI(s) includes the C-RNTI of the UE 102.

The events 535, 537, 538, 540, 542, 544, 546, 548, 550, 552, and 554 are collectively referred to in FIG. 5D as a UE-specific RRC state transition procedure 588.

In some implementations, the UE 102 in the inactive state continues 558 receiving or attempting to receive MBS data for the first MBS session from the DU 174. In such implementations, the UE 102 in the inactive state continues monitoring a PDCCH with a G-RNTI and/or a G-CS-RNTI to receive MBS data of the first MBS session from the DU 174. If the RRC release message includes multicast configuration parameter(s) (e.g., the second multicast configuration parameter(s)), the UE 102 in the inactive state continues 558 receiving or attempting to receive MBS data of the first MBS session from the DU 174 in accordance with the second multicast configuration parameter(s). Otherwise, if the RRC release message does not include multicast configuration parameter(s), the UE 102 in the inactive state continues 558 receiving or attempting to receive MBS data of the first MBS session from the DU 174 in accordance with the first multicast configuration parameters. In some implementations, the UE 102 refrains from suspending the MRB(s) and/or PDCP entities associated with the MRB(s) to continue 558 receiving or attempting to receive MBS data of the first MBS session via the MRB(s) after receiving the RRC release message. In some implementations, the UE 102 refrains from resetting the MAC entity in response to the RRC release message to continue 558 receiving or attempting to receive MBS data of the first MBS session via the MAC entity.

In other implementations, the UE 102 stops or suspends receipt of MBS data from the DU 174 in response to the RRC release message or transitioning 556 to the inactive state. In some such implementations, the UE 102 in the inactive state stops using the G-RNTI and/or the G-CS-RNTI to monitor a PDCCH in response to or when stopping or suspending receipt of MBS data. In some implementations, when the DU 174 receives MBS data (e.g., event 561), the DU 174 transmits (e.g., via multicast or broadcast) 557 a multicast reception indication to the UE 102 to indicate to the UE 102 to receive multicast transmissions. In further implementations, after receiving the multicast reception indication, the UE 102 in the inactive state starts or attempts to receive MBS data of the first MBS session as described below. In some implementations, the multicast reception indication is a paging message (e.g., including the first MBS session ID). In other implementations, the multicast reception indication is a DCI including a particular field (e.g., short message) indicating to the UE 102 to receive multicast transmissions. In some implementations, to transmit the DCI, the DU 174 generates a CRC for the DCI, scrambles the CRC with a paging radio network temporary identifier (P-RNTI), and transmits the DCI and scrambled CRC on a PDCCH monitored by the UE 102. The UE 102 receives the DCI and scrambled CRC on the PDCCH and verifies whether the scrambled CRC is valid. If the UE 102 verifies the scrambled CRC is valid, the UE 102 starts or attempts to receive MBS data of the first MBS session from the DU 174. Otherwise, if the UE 102 verifies the scrambled CRC is invalid, the UE 102 continues to stop or suspend receipt of MBS data from the DU 174.

Depending on the implementation, in response to the CU-to-DU message of event 552, the DU 174 retains the second multicast configuration parameter(s) and releases unicast configuration parameters (e.g., configuration parameters for unicast communication) that the DU 174 configures for the UE 102. Alternatively, the DU 174 releases the second multicast configuration parameter(s). In some implementations, the DU 174 sends a DU-to-CU message (e.g., a UE Context Release Complete message or a UE Context Modification Response message) to the CU-CP 172A in response to the CU-to-DU message of event 552.

After transitioning the UE 102 to the inactive state or while the UE 102 operates in the inactive state, the CU-UP 172B receives 559 MBS data of the first MBS session from the CN 110 and transmits 561 the MBS data to the DU 174, similar to events 532 and 534, respectively. The DU 174 transmits (e.g., via multicast) 563 the MBS data to the UE 102, similar to event 536. For example, the MBS data includes one or more MBS data packets, and the DU 174 transmits 563 one or more multicast transmissions, each including particular MBS data packet(s). The UE 102 in the inactive state receives 563 the MBS data or multicast transmission(s) in accordance with the second multicast configuration parameter(s).

In some implementations, examples or implementations described above for the first multicast configuration parameters apply to the second multicast configuration parameter(s). In some implementations, the second multicast configuration parameter(s) augments the first multicast configuration parameters. In such implementations, the UE 102 augments the first multicast configuration parameters with the second multicast configuration parameter(s). Thus, the UE 102 in the inactive state receives 563 the MBS data in accordance with the second multicast configuration parameter(s), and configuration parameter(s) of the first multicast configuration parameters not augmented by the second multicast configuration parameter(s). In some implementations, the UE 102 retains configuration parameter(s) (e.g., value(s)) augmented by the second multicast configuration parameter(s). In some such implementations, the DU 174 or CU-CP 172A retains configuration parameter(s) augmented by the second multicast configuration parameter(s) for the UE 102. In some implementations, when the UE 102 transitions to the connected state from the inactive state, the UE 102 uses the retained configuration parameter(s) to receive MBS data of the first MBS session from the DU 174. Alternatively, the UE 102 releases the configuration parameter(s) augmented by the second multicast configuration parameter(s).

In some implementations, the first multicast configuration parameters include first configuration(s) configuring the UE 102 to transmit HARQ feedback for multicast transmissions (e.g., including MBS data), and the second multicast configuration parameter(s) releases the first configuration(s). In some implementations, the second multicast configuration parameter(s) include second configuration(s) releasing or disable the first configuration(s). The UE 102 releases or disable the first configuration(s) in response to the second configuration(s). In further implementations, the second multicast configuration parameter(s) exclude the first configuration(s) to indicate to the UE 102 to release or disable the first configuration(s). The UE 102 releases or disable the first configuration(s) in response to the second multicast configuration parameter(s) excluding the first configuration(s).

In other implementations, the UE 102 uses the second multicast configuration parameter(s) to receive 563 the MBS data instead of the first multicast configuration parameters. In some such cases, the UE 102 retains the first multicast configuration parameters. In further implementations, when the UE 102 transitions to the connected state from the inactive state, the UE 102 uses the first multicast configuration parameters to receive MBS data of the first MBS session from the DU 174 instead of the second multicast configuration parameter(s). Alternatively, the UE 102 releases the first multicast configuration parameter(s) in response to the RRC release message.

In some implementations, the second MRB configuration indicates or configures the MRB(s). For example, the second MRB configuration includes MRB ID(s) identifying the MRB(s) respectively. The UE 102 uses the indicated or configured MRB(s) to receive 563 the MBS data. In other implementations, the RRC release message does not include an MRB configuration to indicate or configure the MRB(s). In such implementations, the UE 102 uses all of the MRB(s) configured in the procedure 594 to receive 563 the MBS data.

FIG. 5E illustrates an example scenario 500E similar to the scenario 500D illustrated in FIG. 5D. In some implementations of the scenario 500E, the CU-CP 172A generates an RRC reconfiguration message, including the second multicast configuration parameter(s), instead of an RRC release message, after receiving the second multicast configuration parameter(s) from the DU 174. The CU-CP 172A transmits 567 a CU-to-DU message, including the RRC reconfiguration message, to the DU 174, which in turn transmits 568 the RRC reconfiguration message to the UE 102, similar to events 526 and 528 respectively. In response, the UE 102 transmits 570 an RRC reconfiguration complete message to the DU 174, which in turn transmits 572 a DU-to-CU message, including the RRC reconfiguration complete message, to the CU-CP 172A. In some implementations, the DU 174 generates the second multicast configuration parameter(s) in the same format as the first multicast configuration parameters, and the RRC reconfiguration message does not indicate the multicast configuration parameter(s). In some such cases, the UE 102 does not know the second multicast configuration parameter(s) are specific for the inactive state, and the UE in the connected state receives MBS data of the first MBS session from the DU 174 in accordance with the second multicast configuration parameter(s).

Depending on the implementation, in response to determining to cause the UE 102 to transition to the inactive state, the CU-CP 172A generates an RRC release message (e.g., RRCRelease message or RRCConnectionRelease message) to cause the UE 102 to transition to the inactive state. In some implementations, the CU-CP 172A includes, in the RRC release message, an indication (e.g., multicast inactive enable indication) indicating that the UE 102 receives or continues receiving MBS data after transitioning to the inactive state. The CU-CP 172A transmits 553 the RRC release message to the DU 174, similar to event 552. In turn, the DU 174 transmits 555 the RRC release message to the UE 102, similar to event 554. If the CU-CP 172A transmits 567 the RRC reconfiguration message, the CU-CP 172A transmits 553 the RRC release message after receiving 570 the RRC reconfiguration complete message. The UE 102 transitions 556 to the inactive state from the connected state in response to or upon receiving the RRC release message.

The events 535, 537, 538, 540, 542, 544, 546, 548, 550, 553, and 555 are collectively referred to in FIG. 5E as a UE-specific RRC state transition procedure 589.

The UE 102 determines to continue 558 receiving or attempting to receive MBS data in response to the indication (e.g., multicast inactive enable indication). If the RRC release message does not include the indication (e.g., multicast inactive enable indication), the UE 102 determines not to receive or stops receiving MBS data after receiving the RRC release message or transitioning to the inactive state.

If the CU-CP 172A does not transmit the second multicast configuration parameter(s) to the UE 102 (e.g., events 567, 568, 570, and 572 are omitted), the UE 102 in the inactive state continues using the first multicast configuration parameters to receive 563 the MBS data. Alternatively, in such cases, the UE 102 in the inactive state uses a first portion of the first multicast configuration parameters to receive 563 the MBS data, and refrains from using a second portion or the remaining portion of the first multicast configuration parameters to receive 563 the MBS data.

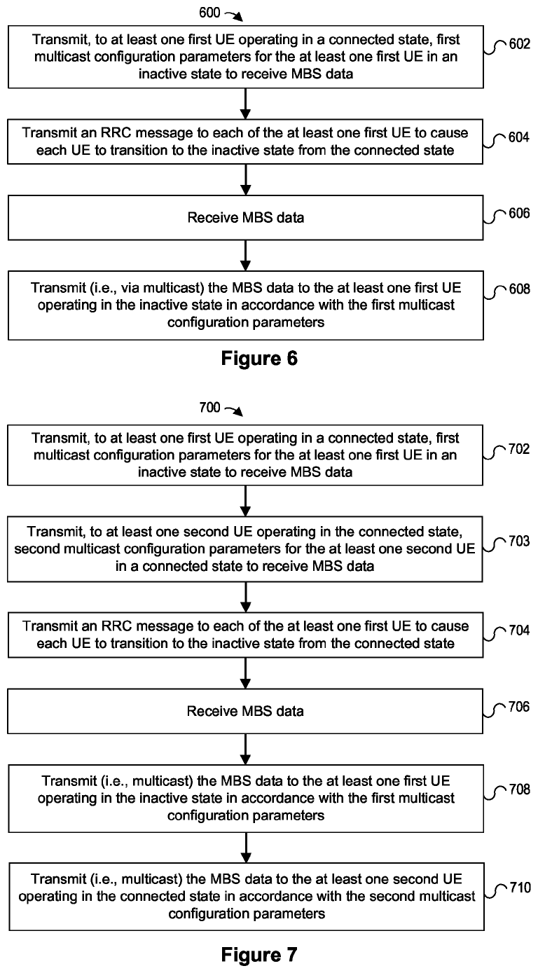

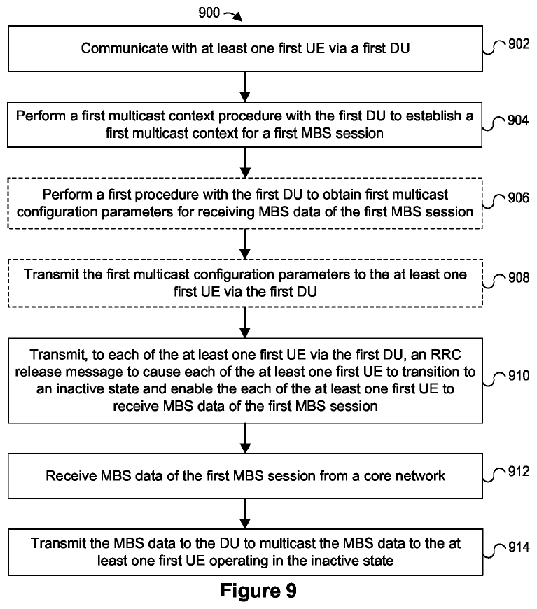

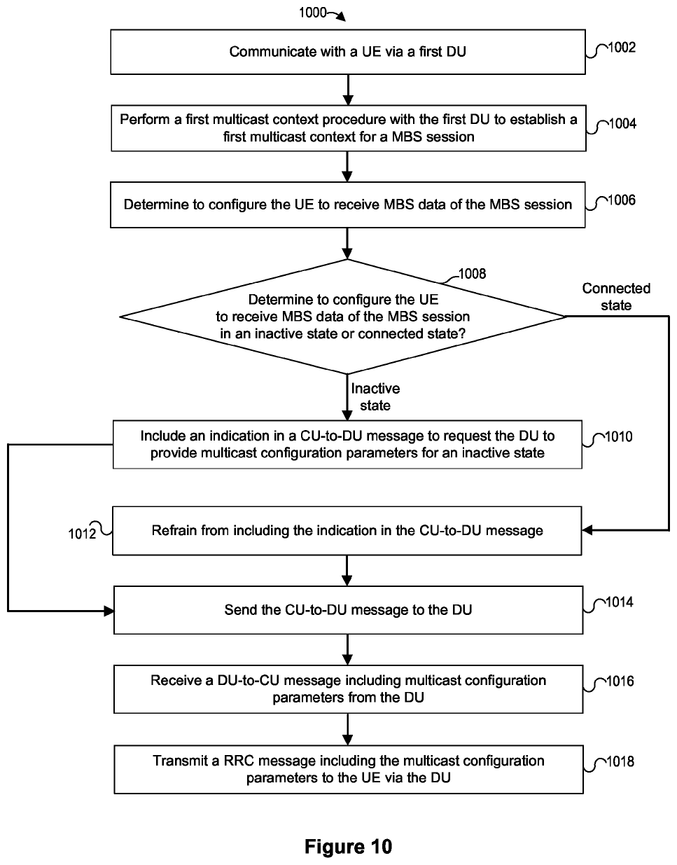

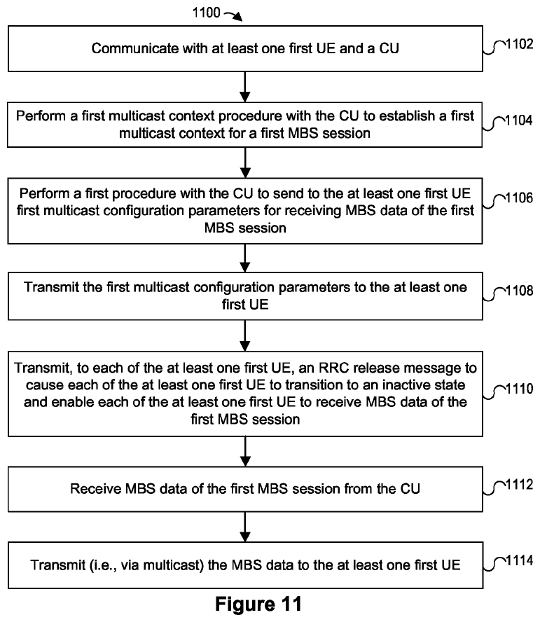

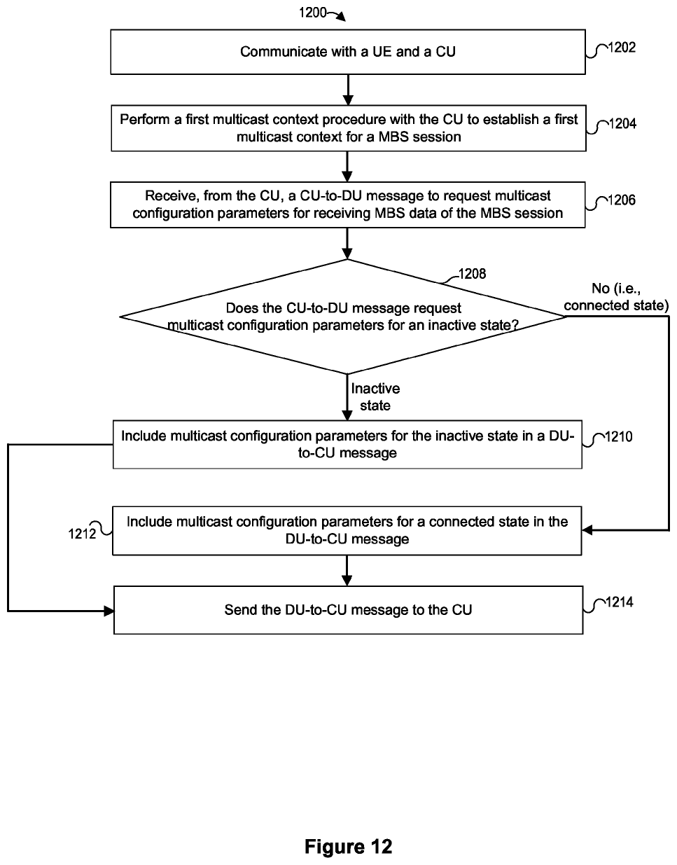

Turning now to FIGS. 6-12, these figures generally illustrate various methods in which a RAN node, a CU, or a DU provides multicast configuration parameters and transmits the MBS data packet for UEs in an inactive state or in a connected state according to the (corresponding) multicast configuration parameters. FIGS. 6-8B illustrate that the RAN node configures a UE to receive MBS data in an inactive state or in a connected state. FIGS. 9-10 illustrate that the CU performs procedure(s) with the DU to configure the UE to receive MBS data in an inactive state or in a connected state, and transmits the MBS data to the UE via the DU. FIGS. 11-12 illustrate that the DU performs procedure(s) with the CU to configure the UE to receive MBS data in an inactive state or in a connected state, and transmits the MBS data to the UE.

Referring first to FIG. 6, a RAN node (e.g., the BS 104 or DU 174) can implement an example method 600 to configure multicast configuration parameters for a UE (e.g., the UE 102) and transmit MBS data packet(s) to the UE operating in an inactive state.

The method 600 starts at block 602, where the RAN node transmits, to at least one first UE operating in a connected state, first multicast configuration parameters for the at least one first UE to receive MBS data packet(s) when in an inactive state (e.g., events 524, 526, 528, 594, 550, 552, 554, 567, 568). At block 604, the RAN node transmits an RRC message to each of the UEs to transition each UE to the inactive state from the connected state (e.g., events 552, 554, 553, 555). At block 606, the RAN node receives MBS data packet(s) (e.g., events 559, 561, 597). If the RAN node is a base station (e.g., the base station 104), the RAN node receives the MBS data packet(s) from a core network (e.g., the CN 110). If the RAN node is a DU (e.g., the DU 174), the RAN node receives the MBS data packet(s) from a CU or CU-UP (e.g., the CU 172 or CU-UP 172B). At block 608, the RAN node transmits (e.g., via multicast) the MBS data to the at least one first UE operating in the inactive state in accordance with the first multicast configuration parameters (e.g., events 561, 563, 597).

In some implementations, the RAN node unicasts the first multicast configuration parameters to each of the UEs. In some implementations, the RAN node transmits the first multicast configuration parameters to at least one second UE and transmits the MBS data to the at least one second UE operating in the connected state via multicast in accordance with first the multicast configuration parameters. In some implementations, the RAN node unicasts the first multicast configuration parameters and the additional multicast configuration parameters to each of the second UEs.

In some implementations, the RAN node transmits the at least one second UE additional multicast configuration parameters for multicast transmission and does not configure the additional multicast configuration parameters for the at least one first UE. In one implementation, the additional multicast configuration parameters include HARQ ACK/NACK configuration parameters for positively or negatively acknowledging multicast transmissions. When one of the at least one second UE successfully receives a multicast transmission, the UE transmits a HARQ ACK to the RAN node in accordance with the HARQ ACK/NAK configuration meters. When one of the at least one second UE fails to receive a multicast transmission, the UE transmits a HARQ NACK to the RAN node in accordance with the HARQ ACK/NAK configuration parameters. The RAN node attempts to receive a HARQ ACK or NACK from the at least one second UE in accordance with the HARQ ACK/NACK configuration parameters.

In other implementations, the RAN node transmits the additional multicast configuration parameters for multicast transmission for the at least one second UE and does not configure the additional multicast configuration parameters for the at least one first UE. In some implementations, the additional multicast configuration parameters include HARQ-NACK-only configuration parameters. When one of the at least one second UE fails to receive a multicast transmission, the UE transmits a HARQ NACK to the RAN node in accordance with the HARQ-NACK-only configuration parameters. The RAN node attempts to receive a HARQ ACK or NACK from the at least one second UE in accordance with the HARQ-NACK-only configuration parameters. The RAN node attempts to receive a NACK from the at least one second UE in accordance with the HARQ ACK/NACK configuration parameters.

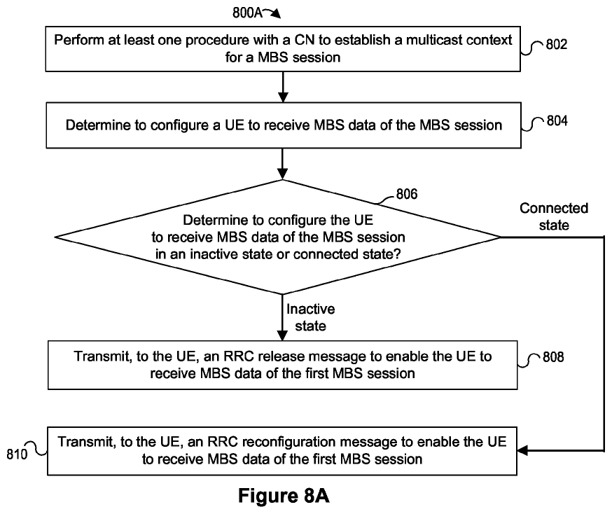

Referring to FIG. 7, a RAN node (e.g., the base station 104 or DU 174) can implement an example method 700 to configure different sets of multicast configuration parameters for at least one first UE (e.g., the UE 102A and/or UE 102B) and at least one second UE (e.g., the UE 103), and transmit MBS data packet(s) to the first UE(s) operating in an inactive state and the second UE(s) in a connected state.

The method 700 starts at block 702, where the RAN node transmits, to at least one first UE operating in a connected state, first multicast configuration parameters for the at least one first UE to receive MBS data packet(s) when in an inactive state (e.g., events 524, 526, 528, 594, 550, 552, 554, 567, 568). At block 703, the RAN node transmits, to at least one second UE, operating in the connected state, second multicast configuration parameters for the at least one second UE in a connected state to receive MBS data packet(s) (e.g., events 524, 526, 528, 594). At block 704, the RAN node transmits an RRC message to each of the at least one first UE to transition the each UE to the inactive state from the connected state (e.g., events 552, 554, 553, 555). At block 706, the RAN node receives MBS data (e.g., events 532, 534, 596, 559, 561, 597). If the RAN node is a base station (e.g., the base station 104), the RAN node receives the MBS data packet(s) from a core network (e.g., the CN 110). If the RAN node is a DU (e.g., the DU 174), the RAN node receives the MBS data packet(s) from a CU or CU-UP (e.g., the CU 172 or CU-UP 172B). At block 708, the RAN node transmits (e.g., via multicast) the MBS data packet(s) to the at least one first UE operating in the inactive state in accordance with the first multicast configuration parameters (e.g., events 561, 563, 597). At block 710, the RAN node transmits (e.g., via multicast) the MBS data packet(s) to the at least one second UE operating in the connected state in accordance with the second multicast configuration parameters (e.g., events 534, 536, 596).

In some implementations, the RAN node unicasts the first multicast configuration parameters to each of the at least one first UE. In some implementations, the RAN node unicasts the second multicast configuration parameters to each of the at least one second UE.

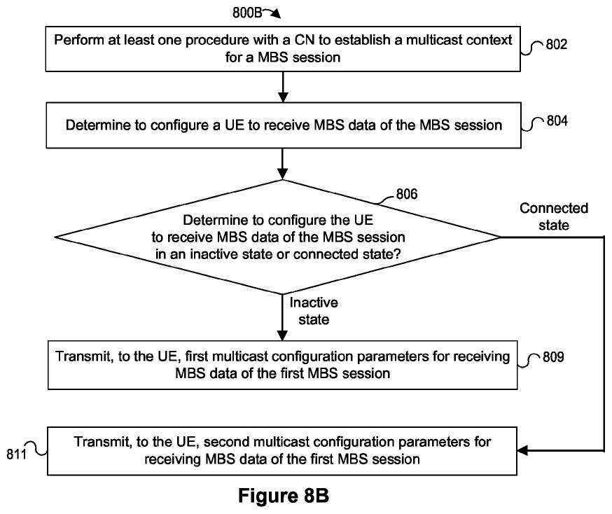

Referring to FIG. 8A, a RAN node (e.g., the base station 104 or CU 172) can implement an example method 800A to enable a UE (e.g., the UE 102) to receive MBS data packet(s) in an inactive state or a connected state.

The method 800A starts at block 802, where the RAN node performs at least one procedure with a CN (e.g., the CN 110) to establish a multicast context for an MBS session (e.g., events 504, 512, 514, 518, 592A. 592B. 592C). At block 804, the RAN node determines to configure a UE to receive MBS data packet(s) of the MBS session. At block 806, the RAN node determines whether to configure the UE to receive MBS data of the MBS session in an inactive state or connected state. If, at block 806, the RAN node determines to configure the UE to receive MBS data packet(s) of the MBS session in an inactive state, the flow proceeds to block 808, where the RAN node transmits, to the UE, an RRC release message to enable the UE to receive MBS data packet(s) of the first MBS session (e.g., events 552, 554, 553, 555). If, at block 806, the RAN node determines to configure the UE to receive MBS data packet(s) of the MBS session in a connected state, the flow proceeds to block 810, where the RAN node transmits, to the UE, an RRC reconfiguration message to enable the UE to receive MBS data of the first MBS session (e.g., events 526, 528, 594). In some implementations, the RAN node receives an RRC reconfiguration message from the UE in response to the RRC reconfiguration message (e.g., events 530, 531).

FIG. 8B is a flow diagram of an example method 800B similar to the method 800A, except that the method 800B includes blocks 809 and 811 instead of blocks 808 and 810.

If, at block 806, the RAN node determines to configure the UE to receive MBS data of the MBS session in an inactive state, the flow proceeds to block 809, where the RAN node transmits, to the UE, first multicast configuration parameters for receiving MBS data of the first MBS session (e.g., events 552, 554, 553, 555, 567, 568). If, at block 806, the RAN node determines to configure the UE to receive MBS data of the MBS session in a connected state, the flow proceeds to block 811, where the RAN node transmits, to the UE, second multicast configuration parameters for receiving MBS data of the first MBS session (e.g., events 526, 528, 594).

Referring to FIG. 9, a CU (e.g., the CU 172, CU-CP 172A or CU-UP 172B) can implement an example method 900 to perform procedures with a DU (e.g., DU 174) to configure a UE (e.g., UE 102) to receive MBS data packet(s) via the DU.

The method 900 starts at block 902, where the CU communicates with at least one first UE via a first DU (e.g., event 502). At block 904, the CU performs a first multicast context procedure with the first DU to establish a first multicast context for a first MBS session (e.g., events 506, 508, 592A, 592B. 592C). At block 906, the CU performs a first procedure with the first DU to obtain first multicast configuration parameters for receiving MBS data of the first MBS session (e.g., events 522, 524, 594, 548, 550). At block 908, the CU transmits the first multicast configuration parameters to the at least one first UE via the first DU (e.g., events 526, 528, 594, 566, 568). At block 910, the CU transmits, to each of the first UEs via the first DU, an RRC release message to cause each of the first UEs to transition to an inactive state and to enable each of the first UEs to receive MBS data of the first MBS session (e.g., events 552, 554, 553, 555). At block 912, the CU receives MBS data of the first MBS session from a core network (e.g., events 559, 597). At block 914, the CU transmits the MBS data to the DU to multicast the MBS data to the at least one first UE operating in the inactive state (e.g., events 561, 597).

Referring to FIG. 10, a CU (e.g., the CU 172 or CU-CP 172A) can implement a method 1000 perform procedures with a DU (e.g., DU 174) to configure a UE (e.g., UE 102) to receive MBS data packet(s) via the DU in a connected state or in an inactive state.

The method 1000 starts at block 1002, where the CU communicates with a UE via a first DU (e.g., event 502). At block 1004, the CU performs a first multicast context procedure with the first DU to establish a first multicast context for an MBS session (e.g., events 506, 508, 592A. 592B, 592C). At block 1006, the CU determines to configure the UE to receive MBS data of the MBS session. At block 1008, the CU determines whether to configure the UE to receive MBS data of the MBS session in an inactive state or connected state.

If the CU, at block 1008, determines to configure the UE to receive MBS data of the MBS session in an inactive state, the flow proceeds to block 1010, where the CU includes an indication in a CU-to-DU message to request the DU to provide multicast configuration parameters for an inactive state. The flow then proceeds to block 1014, where the CU sends the CU-to-DU message to the DU (e.g., event 548). At block 1016, the CU receives a DU-to-CU message including multicast configuration parameters from the DU (e.g., event 550). At block 1018, the CU transmits an RRC message, including the multicast configuration parameters, to the UE via the DU (e.g., events 552, 554).

If the CU, at block 1008, determines to configure the UE to receive MBS data of the MBS session in a connected state, the flow proceeds to block 1012, where the CU refrains from including an indication in a CU-to-DU message to request the DU to provide multicast configuration parameters for an inactive state. The flow then proceeds from block 1012 to block 1014, where the CU sends the CU-to-DU message to the DU (e.g., events 522, 594). At block 1016, the CU receives a DU-to-CU message, including multicast configuration parameters, from the DU (e.g., events 524, 594). At block 1018, the CU transmits an RRC message, including the multicast configuration parameters, to the UE via the DU (e.g., events 526, 528, 594).

Referring to FIG. 11, a DU (e.g., the DU 174) can implement method 1100 to perform procedures with a CU (e.g., the CU 172, CU-CP 172A or CU-UP 172B) to send multicast configuration parameters and transmit MBS data packet(s) to a UE (e.g., UE 102) via multicast.

The method 1100 starts at block 1102, where the DU communicates with at least one first UE and a CU (e.g., event 502). The DU, at block 1104, performs a first multicast context procedure with the CU to establish a first multicast context for a first MBS session (e.g., events 506, 508, 592A, 592B, 592C). At block 1106, the DU performs a first procedure with the CU to send, to the at least one first UE, first multicast configuration parameters for receiving MBS data of the first MBS session (e.g., events 522, 524, 594, 548, 550). At block 1108, the DU transmits the first multicast configuration parameters to the at least one first UE (e.g., events 526, 528, 594, 566, 568). At block 1110, the DU transmits, to each of the first UEs, an RRC release message to cause each of the first UEs to transition to an inactive state and to enable each of the first UEs to receive MBS data of the first MBS session (e.g., events 552, 554, 553, 555). The DU at block 1112 receives MBS data of the first MBS session from the CU (e.g., events 534, 561). The DU, at block 1114, transmits (e.g., multicasts) the MBS data to the least one first UE operating in the inactive state (e.g., events 563, 597).

Referring to FIG. 12, a DU (e.g., the DU 174) can implement method 1200 to perform procedures with a CU (e.g., the CU 172, CU-CP 172A or CU-UP 172B) to send multicast configuration parameters and transmit MBS data packet(s) to a UE (e.g., UE 102) via multicast.

The method 1200 starts at block 1202, where the DU communicates with a UE and a CU (e.g., event 502). At block 1204, the DU performs a first multicast context procedure with the CU to establish a first multicast context for an MBS session (e.g., events 506, 508, 592A, 592B, 592C). At block 1206, the DU receives, from the CU, a CU-to-DU message to request multicast configuration parameters for receiving MBS data of the MBS session (e.g., events 522, 594, 548). At block 1208, the DU determines whether the CU-to-DU message requests multicast configuration parameters for an inactive state.

If the CU-to-DU message requests multicast configuration parameters for an inactive state, the flow proceeds to block 1206, where the DU includes multicast configuration parameters for the inactive state in a DU-to-CU message. The DU then, at block 1212, sends the DU-to-CU message to the CU (e.g., event 550).

If the CU-to-DU message does not request multicast configuration parameters for an inactive state (e.g., the CU-to-DU message requests multicast configuration parameters for a connected state), the flow proceeds to block 1210, where the DU includes multicast configuration parameters for the connected state in a DU-to-CU message. The DU then, at block 1212, sends the DU-to-CU message to the CU (e.g., events 524, 594).

The following list of examples reflects a variety of the embodiments explicitly contemplated by the present disclosure:

Example 1. A multicast and/or broadcast services (MBS) communication method implemented in a radio access network (RAN), the method comprising: determining whether a UE operating in a connected state is to receive MBS data in the connected state or an inactive state; in a first instance, in response to determining that the UE is to receive the MBS data in the connected state, transmitting a first multicast configuration to the UE; and in a second instance, in response to determining that the UE is to receive the MBS data in the inactive state, transmitting a second multicast configuration to the UE.

Example 2. The method of example 1, wherein: the transmitting of the first multicast configuration to the UE includes transmitting a radio resource control (RRC) reconfiguration command to the UE, the RRC reconfiguration command including the first multicast configuration.

Example 3. The method of example 1 or 2, wherein: the transmitting of the second multicast configuration to the UE includes transmitting an RRC release command to the UE, the RRC release command including the first multicast configuration.

The following additional considerations apply to the foregoing discussion.

Generally speaking, description for one of the above figures can apply to another of the above figures. An event or block described above can be optional or omitted. For example, an event or block with dashed lines in the figures can be optional or omitted. In some cases, an event or block with solid lines in the figures can still be optional or omitted if the event or block is not necessary. In some implementations, “message” is used and can be replaced by “information element (IE)”. In some implementations, “IE” is used and can be replaced by “field”. In some implementations, “configuration” can be replaced by “configurations” or the configuration parameters. In some implementations, “MBS” can be replaced by “multicast” or “multicast MBS”. In some implementations, “MBS data” can be replaced by “multicast transmission(s)”. In some implementations, “multicast MBS” and “multicast transmission(s)” are interchangeable. In some implementations, “multicast communication”, “multicast reception” and “multicast transmission” are interchangeable. In some implementations, “SPS multicast” can be replaced by “multicast SPS”. Similarly, “dynamic scheduling multicast” can be replaced by “multicast dynamic”. In some implementations, “identifier” can be replaced by “identity”. In some implementations, “CFR” is used and can be replaced by “MBS BWP”. In some implementations, the term “transport layer configuration” can be replaced by “tunnel information” or “transport layer information”. In some implementations, “in accordance with” can be replaced by “using”. In some implementations, “unicast communication” can replaced by “unicast data communication”.

A user device in which the techniques of this disclosure can be implemented (e.g., the UE 102A, 102B, or UE 103) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional alternative structural and functional designs for performing a HARQ process to transmit MBS data through the disclosed principles herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A multicast and/or broadcast services (MBS) communication method implemented in a radio access network (RAN), the method comprising:
transmitting, to a first UE operating in a connected state, a first multicast configuration for receiving MBS data in the inactive state;
transmitting, to a second UE operating in the connected state, a second multicast configuration for receiving the MBS data in the connected state; and
transmitting the MBS data to: (i) the first UE operating in the inactive state, according to the first multicast configuration, and (ii) the second UE operating in the connected state, according to the second multicast configuration.

2. The method of claim 1, wherein the first multicast configuration includes a scheduling parameter.

3. The method of claim 1, wherein the first multicast configuration includes an MBS radio bearer (MRB) configuration.

4. The method of claim 1, wherein the first multicast configuration and the second multicast configuration include a parameter for a multicast traffic channel (MTCH).

5. The method of claim 1, wherein the first multicast configuration is different from the second multicast configuration.

6. The method of claim 1, wherein the transmitting of the first multicast configuration to the first UE includes:
transmitting a command to transition from the connected state to the inactive state, the command including the first multicast configuration.

7. The method of claim 1, wherein the transmitting of the second multicast configuration to the second UE includes:
transmitting a radio resource control (RRC) reconfiguration command to the UE, the command including the second multicast configuration.

8. The method of claim 1, further comprising:
receiving the MBS data associated with an MBS session which the first UE and the second UE joined.

9. The method of claim 8, further comprising:
wherein the MBS session is associated with a Temporary Mobile Group Identity (TMGI).

10. The method of claim 8, further comprising:
establishing, with a core network (CN), a multicast context corresponding to the MBS session.

11. The method of claim 1, wherein:
the transmitting of the first multicast configuration to the first UE is in response to determining that the first UE will receive the MBS data in the inactive state; and
the transmitting of the second multicast configuration to the second UE is in response to determining that the second UE will receive the MBS data in the connected state.

12. The method of claim 1, wherein:
the transmitting of the first multicast configuration to the first UE includes transmitting an RRC release command, in response to determining that the first UE will receive the MBS data in the inactive state.

13. The method of claim 1, wherein:
the transmitting of the second multicast configuration to the second UE includes transmitting an RRC reconfiguration command, in response to determining that second first UE will receive the MBS data in the connected state.

14. (canceled)

15. An apparatus, operating as a radio access network (RAN) node and configured for multicast and/or broadcast services (MBS) communication, the apparatus comprising:
a transceiver; and
processing hardware configured to:
transmit, to a first UE operating in a connected state, a first multicast configuration for receiving MBS data in the inactive state;
transmit, to a second UE operating in the connected state, a second multicast configuration for receiving the MBS data in the connected state; and
transmit the MBS data to: (i) the first UE operating in the inactive state, according to the first multicast configuration, and (ii) the second UE operating in the connected state, according to the second multicast configuration.

16. The apparatus of claim 15, wherein the first multicast configuration includes a scheduling parameter.

17. The apparatus of claim 15, wherein the first multicast configuration includes an MBS radio bearer (MRB) configuration.

18. The apparatus of claim 15, wherein the first multicast configuration and the second multicast configuration include a parameter for a multicast traffic channel (MTCH).

19. The apparatus of claim 15, wherein the first multicast configuration is different from the second multicast configuration.

20. The apparatus of claim 15, wherein transmitting the first multicast configuration to the first UE includes:
transmitting a command to transition from the connected state to the inactive state, the command including the first multicast configuration.

21. The apparatus of claim 15, wherein transmitting the second multicast configuration to the second UE includes:
transmitting a radio resource control (RRC) reconfiguration command to the UE, the command including the second multicast configuration.
